(19) United States
(12) Patent Application Publication
(10) Pub. No.: US 2011/0039459 A1
(43) Pub. Date: Feb. 17, 2011

(54) Solderless carbon nanotube and nanowire electrical contacts and methods of use thereof

(76) Inventor: Jerry W. Yancey, Rockwall, TX (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/462,923

(22) Filed: Aug. 11, 2009

(51) Int. Cl. H01R 13/02; H01B 5/00

(52) U.S. Cl. 439/884; 174/128.1; 977/742; 977/762

(57) ABSTRACT

Solderless and durable electrical contacts may be made by growing carbon nanotube (CNT) or nanowire forests in a solderless manner directly on the contact surfaces of integrated circuits, PCBs, IC packages, hybrid substrates, contact carriers, rotor components, stator components, etc. The electrical contacts and methods may be employed in a variety of leaded and leadless electronic packaging applications on PCBs, IC packages, and hybrid substrates including, but not limited to, ball grid array (BGA) packages, land grid array (LGA) and leadless chip carrier (LCC) packages, as well as for making interconnections in “flip-chip” configurations, “bare die” configurations, and interconnection of integrated circuit die in multi-layer and “3-D” stacking arrangements.

### FIELD OF THE INVENTION

This invention relates generally to electrical contacts, and more particularly to carbon nanotube and nanowire electrical contacts and methods of using same.

### BACKGROUND OF THE INVENTION

Conventional low insertion force and zero insertion force socketing methods employ springs, flexible contacts, and wipers to make an electrical connection to the contacts on the parts. Such mechanical socketing methods become increasingly difficult to reliably deploy as component lead sizes and pitch decrease. Other interconnection methods for die-to-die contacts employ solder balls and bumps in combination with ball grid array (BGA)-like mounting techniques that employ high-temperature cycling. Such methods are stressful to relatively fragile die, and are difficult to reverse without damaging components. Other methods exist that involve the use of wireless interfaces to interconnect die, and introduce complexity into the electrical design of the part. Wireless interfaces do not conduct power through the stack. Other interconnection methods for flip-chip die-to-package contacts involve the use of solder balls and bumps in combination with BGA-like mounting techniques that also employ high-temperature cycling. Such methods are also stressful to relatively fragile die and are difficult to reverse without damaging the die.

Conventional board to board connector devices have employed pin connectors that are received between metal spring contacts within corresponding connector receptacles, and printed circuit board (PCB) cards having connectors have been employed that are received between metal spring contacts of corresponding card edge connectors. However metal spring contacts are prone to fatigue and weakness over time, resulting in loss of electrical connections between mating components.

Carbon Nanotubes (CNTs) have diameters in nanometers, are highly conductive over short distances, and are very durable. CNTs can be grown in vertically-aligned arrays of fibers (as “forests”, “carpets or” “lawns”) which are themselves very small (measured in micrometers). Each fiber in such a CNT fiber array consists of many individual nanotubes and exhibits reasonable conductivity and flexibility over short distances.

Nanowires have diameters that range from nanometers to hundreds of nanometers and can be grown in vertically-aligned arrays similar to that described for CNTs above. Nanowires can be made from a variety of materials such as Zinc Oxide, Silicon, Germanium, etc. Nanowire arrays are stiffer than CNT forests, but are also more conductive.

### SUMMARY OF THE INVENTION

Disclosed herein are methods of socketing and/or making component connections that are solderless and durable and electrical contacts that are made using the same. In this regard, durable electrical contacts (e.g., including contacts for zero insertion force and low insertion force connector applications) may be made by growing carbon nanotube (CNT) or nanowire forests in a solderless manner directly on the contact surfaces of integrated circuits, PCBs, IC packages, hybrid substrates, contact carriers, rotor components, stator components, etc. The electrical contacts and methods may be employed in a variety of leaded and leadless electronic packaging applications on PCBs, IC packages, and hybrid substrates including, but not limited to, ball grid array (BGA) packages, land grid array (LGA) and leadless chip carrier (LCC) packages, as well as for making interconnections in “flip-chip” configurations, “bare die” configurations, and interconnection of integrated circuit die in multi-layer and “3-D” stacking arrangements.

Using the electrical contacts of the disclosed methods, parts may be easily lifted off the contacts and replaced many times while the contacts maintain their functionality. In one embodiment, solderless and durable electrical contacts for zero insertion force and low insertion force applications may be made by growing CNT or nanowire forests in a solderless manner directly on the contact surfaces presented on both sides of a contact carrier. The carrier may in turn serve to position and hold one or more contacts between the surfaces of integrated circuits (ICs), printed-circuit boards (PCBs), IC packages, and hybrid substrates (e.g., multi-chip-modules). In another embodiment, multiple solderless and durable electrical contacts for zero insertion force and low insertion force applications may be made by growing CNT or nanowire forests in a solderless manner directly on the contact surfaces of integrated circuits, PCBs, IC packages, and hybrid substrates. The disclosed multiple solderless and durable electrical contacts may also be employed for making electrical connection between parts that are moving relative to each other, e.g., stator/rotor interconnects, electric motor brush interconnections, etc. The disclosed electrical contacts may be implemented with relatively short (e.g., from about 0.1 mm to about 0.5 mm) CNT forests that are grown in a pattern directly on the contacts of various electrical connection structures.

CNT and nanowire fiber sizes of the disclosed electrical contacts advantageously allow for thousands of contact points with even the finest component and IC die contact pitches. Moreover, the flexibility of the CNT and nanowire forests allow electrical contacts to be implemented in a manner that accounts for irregularities in the size and alignment of rigid contact surfaces as well as mismatches in the coefficient of thermal expansion (CTE) between the rigid contact surfaces. In addition, the disclosed electrical contacts may be implemented with semiconductor die in a manner that subjects dies to less stress during package mounting, and in a manner that increases manufacturing yields by subjecting die to less stress during package mounting. In this regard, CNTs and/or nanowires may be locally grown on contact surfaces in a manner facilitated by local heating elements (e.g., microheater elements) in optional combination with heat sinks which do not damage nearby structures in PCBs and integrated circuits. This is advantageous since the growth of CNTs and nanowires typically requires temperatures which may damage other electronics materials, such as CMOS integrated circuits, electronic components such as resistors and capacitors, and printed circuit cards. In one embodiment, the microheater elements may be thermally isolated without a heat sink by “floating” them via thermally resistive mechanical bridges made via MEMS micromachining techniques. In another embodiment, CNT (or nanowire) growth may be stimulated via direct laser writing. In yet another embodiment, the CNT (or nanowire) forest may be transferred from another surface using micro imprint and contact adhesion techniques. Moreover, the disclosed methods and electrical contacts may also be easily scaled downward in size for different applications, and may be implemented in a manner that facilitates repair and replacement of individual die in a stacked die assembly.

Examples of particular electrical contact applications which may implemented with the disclosed contacts and methods include, but are not limited to, solderless and durable mounting and removable ball grid array (BGA) packages on PCBs, IC packages, MEMS packages, and hybrid substrates; solderless and durable mounting and removal of other leaded surface-mounted integrated circuit packages (e.g., “gull-wing”, etc.) on PCBs, IC packages, and hybrid substrates; solderless and durable mounting and removal of land grid array (LGA) and leadless chip carrier (LCC) packages on PCBs, IC packages, MEMS packages, and hybrid substrates; solderless and durable interconnections of integrated circuit die packages in the “flip-chip” configuration; solderless and durable interconnections of integrated circuit die packages in the “bare die” configuration; solderless and durable interconnections of integrated circuit die in multi-layer and “3-D” stacking arrangements. Each of the foregoing applications may be implemented in one embodiment for zero insertion force and low insertion force connector applications.

In one embodiment, relatively short CNT forests (e.g. from about 0.1 mm to about 0.5 mm in length) may be grown in a solderless manner on both sides of the contacts in a captured contact array. The captured contact array may be sandwiched between devices with fixed contacts (PCB, IC package, bare die, flip-chip die) and a target surface with fixed contacts (such as a PCB, IC package, bare die, or hybrid substrate) end then mechanically constrained with a retainer clip. The retainer clip may then be removed so that the component may be easily lifted off the board. Even with very fine component contact pitches (e.g., such has 0.050 inch), CNT fiber sizes still provide thousands of contact points in this embodiment. Moreover, the flexibility of the CNT forest acts to account for and compensate for irregularities in rigid part contact geometries as well as any mismatch in the CTE between the two rigid surfaces.

In another embodiment, relatively short CNT forests (e.g., from about 0.1 mm to about 0.5 mm in length) may be grown in a solderless manner directly on the contacts of a rigid surface such as a PCB, IC package, or bare die. When this rigid surface is then mechanically constrained to a target surface with matching fixed contacts (such as a PCB, IC package, bare die, or hybrid substrate), reliable electrical contact is established. When the constraint is then removed, the surfaces may easily be separated. For example, in one exemplary implementation, multiple die may be assembled in a stack one upon another and then mechanically constrained with a retainer clip in order to facilitate electrical contact and interconnection between the individual devices. When the retainer clip is then removed, the various die of the stacked assembly may be easily separated, e.g., to accommodate for repair and/or upgrade activities, and/or eliminating the yield and manufacturing losses related to “known good die” issues. Even with the finest die contact pitches (e.g., such as 0.010″), CNT fiber sizes still allow for thousands of contact points in this embodiment. Moreover, the flexibility of the CNT forest acts to account for irregularities in rigid die contact geometries (steps, plateaus, and other shapes) as well as mismatch in the CTE between various die. The thermal conductivity of the CNT fibers also allows for heat conduction through the die stack.

In yet another embodiment, relatively short CNT forests (e.g., from about 0.1 mm to about 0.5 mm in length) may be grown in a solderless manner and in a pattern on the contacts of an integrated circuit package known as a “flip-chip”. Such packages ordinarily include a die which is soldered in place in the package using BGA-style “bump” contacts on one side of the die. However, in one embodiment of the disclosed apparatus and methods, a flip chip type die with fixed contacts may be placed on the CNT contact array in the package and then mechanically constrained in order for the part to make contact with the package. In such an embodiment, when the package is opened, the die may be easily removed and replaced. Even the finest die contact pitches (0.010″), CNT fiber sizes still allow for thousands of contact points in this embodiment. Moreover, the flexibility of the CNT forest accounts for irregularities in rigid die contact geometries as well as mismatch in the CTE between the component and package materials.

In yet another embodiment, one or more relatively short CNT forests (e.g., from about 0.1 mm to about 0.5 mm in length) may be grown in a solderless manner directly on an edge connector contact pad of a rigid surface such as a PCB. When this edge connector contact pad is then inserted between mating spring contacts of a card edge connector, reliable electrical contact is established. Alternatively, one or more relatively short CNT forests may be grown on contact surfaces of card edge connector spring contacts to achieve reliable electrical contact with a edge connector pad of a PCB or other card.

In yet another embodiment, one or more relatively short CNT forests (e.g., from about 0.1 mm to about 0.5 mm in length) may be grown in a solderless manner directly on a rigid contact surface of a connector pin. When this connector pin is then inserted between mating spring contacts of a socket connector, reliable electrical contact is established. Alternatively, one or more relatively short CNT forests may be grown on contact surfaces of a socket connector spring contact to achieve reliable electrical contact with a connector pin.

In one respect, disclosed herein is an electrical interconnection system, including: a first assembly having at least one conductive contact surface disposed thereon; multiple carbon nanotube fibers or nanowires grown directly on the at least one contact surface of the first assembly, a first end of each of the multiple carbon nanotubes or nanowire fibers being permanently attached to the contact surface of the first assembly in a solderless manner; and a second assembly positioned adjacent to the first assembly and having at least one conductive contact surface disposed thereon, the at least one contact surface of the second assembly being at least partially aligned with the at least one contact surface of the first assembly such that at least a portion of the individual carbon nanotube fibers or nanowires of the first assembly makes electrical and mechanical contact with the at least one conductive contact surface of the second assembly.

In another respect, disclosed herein is a method of making electrical interconnections, including: providing a first assembly having at least one conductive contact surface disposed thereon, wherein multiple carbon nanotube fibers or nanowires are grown directly on the at least one contact surface of the first assembly, a first end of each of the multiple carbon nanotubes or nanowire fibers being permanently attached to the contact surface of the first assembly in a solderless manner; and providing a second assembly positioned adjacent to the first assembly and having at least one conductive contact surface disposed thereon, the at least one contact surface of the second assembly being at least partially aligned with the at least one contact surface of the first assembly such that at least a portion of the individual carbon nanotube fibers or nanowires of the first assembly makes electrical and mechanical contact with the at least one conductive contact surface of the second assembly.

In another respect, disclosed herein is a device with an electrical interconnect, including: a device substrate; at least one external conductive contact surface disposed on an external surface of the device substrate; and multiple carbon nanotube fibers or nanowires grown directly on the at least one external contact surface of the first assembly, a first end of each of the multiple carbon nanotubes or nanowire fibers being permanently attached to the contact surface of the first assembly in a solderless manner and a second end of each of the multiple carbon nanotubes or nanowire fibers freely extending outward for interconnection with another device.

### BRIEF DESCRIPTION OF THE DRAWINGS

FIG. 1 is a perspective cross-sectional view of a carrier substrate assembly according to one exemplary embodiment of the disclosed apparatus and methods.

FIG. 2 is a partial perspective view of CNT (or nanowire) forests grown on each of the opposing contact pads of carrier substrate assembly according to one exemplary embodiment of the disclosed apparatus and methods.

FIG. 3 illustrates a partial side cross sectional view of a captured contact array positioned between a first device and a second device according to one exemplary embodiment of the disclosed apparatus and methods.

FIG. 4 illustrates a partial side cross sectional view of a captured contact array positioned between a first device and a second device with retainer clip and thermal foam according to one exemplary embodiment of the disclosed apparatus and methods.

FIG. 5 illustrates a perspective view of a captured contact array positioned between a first device and a second device with retainer clip according to one exemplary embodiment of the disclosed apparatus and methods.

FIG. 6 illustrates a partial side cross sectional view of a captured contact array positioned between a first device and a second device according to one exemplary embodiment of the disclosed apparatus and methods.

FIG. 7 illustrates a partial side cross sectional view of a captured contact array positioned between a first device and a second device according to one exemplary embodiment of the disclosed apparatus and methods.

FIG. 8 illustrates a perspective view of a captured contact array positioned between a first device and a second device with retainer clip according to one exemplary embodiment of the disclosed apparatus and methods.

FIG. 9 illustrates a partial side cross sectional view of a captured contact array positioned between a first device and a second device according to one exemplary embodiment of the disclosed apparatus and methods.

FIG. 10 illustrates a partial side cross sectional view of a captured contact array positioned between a first device and a second device according to one exemplary embodiment of the disclosed apparatus and methods.

FIG. 11 is a partial perspective cross-sectional view of a substrate assembly according to one exemplary embodiment of the disclosed apparatus and methods.

FIG. 12 is a partial perspective view of CNT (or nanowire) forests grown on a contact pad of a substrate assembly according to one exemplary embodiment of the disclosed apparatus and methods.

FIG. 13 illustrates a partial side cross sectional view of a first device positioned adjacent a substrate assembly according to one exemplary embodiment of the disclosed apparatus and methods.

FIG. 14 illustrates a partial side cross sectional view of a first device positioned between a substrate assembly and retainer clip/thermal foam according to one exemplary embodiment of the disclosed apparatus and methods.

FIG. 15 illustrates a perspective view of a first device positioned between a substrate assembly and a retainer clip according to one exemplary embodiment of the disclosed apparatus and methods.

FIG. 16 illustrates a partial side cross sectional view of a first device positioned adjacent a substrate assembly according to one exemplary embodiment of the disclosed apparatus and methods.

FIG. 17 illustrates a partial side cross sectional view of a first device positioned adjacent a substrate assembly according to one exemplary embodiment of the disclosed apparatus and methods.

FIG. 18 illustrates a perspective view of a first device positioned between a substrate assembly and a retainer clip according to one exemplary embodiment of the disclosed apparatus and methods.

FIG. 19 illustrates a partial side cross sectional view of a first device positioned adjacent a substrate assembly according to one exemplary embodiment of the disclosed apparatus and methods.

FIG. 20 illustrates a partial side cross sectional view of a first device positioned adjacent a substrate assembly according to one exemplary embodiment of the disclosed apparatus and methods.

FIG. 21 illustrates a perspective view of two bare die positioned between a substrate assembly and a retainer clip according to one exemplary embodiment of the disclosed apparatus and methods.

FIG. 22 illustrates a side view of a connector pin according to one exemplary embodiment of the disclosed apparatus and methods.

FIG. 23 illustrates surface of connector pin according to one exemplary embodiment of the disclosed apparatus and methods.

FIG. 24 illustrates a side cross-sectional view of a cylindrical connector pin aligned and positioned for sliding insertion into a corresponding cylindrical connector receptacle according to one exemplary embodiment of the disclosed apparatus and methods.

FIG. 25 illustrates a side cross-sectional view of a cylindrical connector pin inserted into a corresponding cylindrical connector receptacle according to one exemplary embodiment of the disclosed apparatus and methods.

FIG. 26 illustrates a side cross-sectional view of a cylindrical connector pin aligned and positioned for sliding insertion into a corresponding cylindrical connector receptacle according to one exemplary embodiment of the disclosed apparatus and methods.

FIG. 27 illustrates a side cross-sectional view of a cylindrical connector pin inserted into a corresponding cylindrical connector receptacle according to one exemplary embodiment of the disclosed apparatus and methods.

FIG. 28 illustrates a side cross-sectional view of a cylindrical connector pin aligned and positioned for sliding insertion into a corresponding cylindrical connector receptacle according to one exemplary embodiment of the disclosed apparatus and methods.

FIG. 29 illustrates a side cross-sectional view of a cylindrical connector pin inserted into a corresponding cylindrical connector receptacle according to one exemplary embodiment of the disclosed apparatus and methods.

FIG. 30 illustrates a side cross-sectional view of a cylindrical connector pin aligned and positioned for sliding insertion into a corresponding cylindrical connector receptacle according to one exemplary embodiment of the disclosed apparatus and methods.

FIG. 31 illustrates a side cross-sectional view of a cylindrical connector pin inserted into a corresponding cylindrical connector receptacle according to one exemplary embodiment of the disclosed apparatus and methods.

FIG. 32 illustrates a illustrates a side cross-sectional view of a cylindrical connector pin aligned and positioned for sliding insertion into a corresponding cylindrical connector receptacle according to one exemplary embodiment of the disclosed apparatus and methods.

FIG. 33 illustrates a side cross-sectional view of a cylindrical connector pin inserted into a corresponding cylindrical connector receptacle according to one exemplary embodiment of the disclosed apparatus and methods.

FIG. 34 shows an end on view of a cylindrical connector receptacle according to one exemplary embodiment of the disclosed apparatus and methods.

FIG. 35 illustrates a illustrates a side cross-sectional view of a cylindrical connector pin aligned and positioned for sliding insertion into a corresponding cylindrical connector receptacle according to one exemplary embodiment of the disclosed apparatus and methods.

FIG. 36 illustrates a side cross-sectional view of a cylindrical connector pin inserted into a corresponding cylindrical connector receptacle according to one exemplary embodiment of the disclosed apparatus and methods.

FIG. 37 shows an end on view of a cylindrical connector receptacle according to one exemplary embodiment of the disclosed apparatus and methods.

FIG. 38 is a perspective view of a PCB card according to one exemplary embodiment of the disclosed apparatus and methods.

FIG. 39 illustrates a side cross-sectional view of a PCB card aligned and positioned for sliding insertion into a corresponding card edge connector according to one exemplary embodiment of the disclosed apparatus and methods.

FIG. 40 illustrates a side cross-sectional view of a PCB card inserted into a corresponding card edge connector according to one exemplary embodiment of the disclosed apparatus and methods.

FIG. 41 is a perspective view of a PCB card according to one exemplary embodiment of the disclosed apparatus and methods.

FIG. 42 illustrates a side cross-sectional view of a PCB card aligned and positioned for sliding insertion into a corresponding card edge connector according to one exemplary embodiment of the disclosed apparatus and methods.

FIG. 43 illustrates a side cross-sectional view of a PCB card inserted into a corresponding card edge connector according to one exemplary embodiment of the disclosed apparatus and methods.

FIG. 44 shows a perspective view of a card connector according to one exemplary embodiment of the disclosed apparatus and methods.

FIG. 45 illustrates a side cross-sectional view of a PCB card aligned and positioned for sliding insertion into a corresponding card edge connector according to one exemplary embodiment of the disclosed apparatus and methods.

FIG. 46 illustrates a side cross-sectional view of a PCB card inserted into a corresponding card edge connector according to one exemplary embodiment of the disclosed apparatus and methods.

FIG. 47 shows a perspective view of a card connector according to one exemplary embodiment of the disclosed apparatus and methods.

FIG. 48 illustrates a side cross-sectional view of a PCB card aligned and positioned for sliding insertion into a corresponding card edge connector according to one exemplary embodiment of the disclosed apparatus and methods.

FIG. 49 illustrates a side cross-sectional view of a PCB card inserted into a corresponding card edge connector according to one exemplary embodiment of the disclosed apparatus and methods.

FIG. 50 illustrates a side perspective view of a slip ring assembly according to one exemplary embodiment of the disclosed apparatus and methods.

### DESCRIPTION OF ILLUSTRATIVE EMBODIMENTS

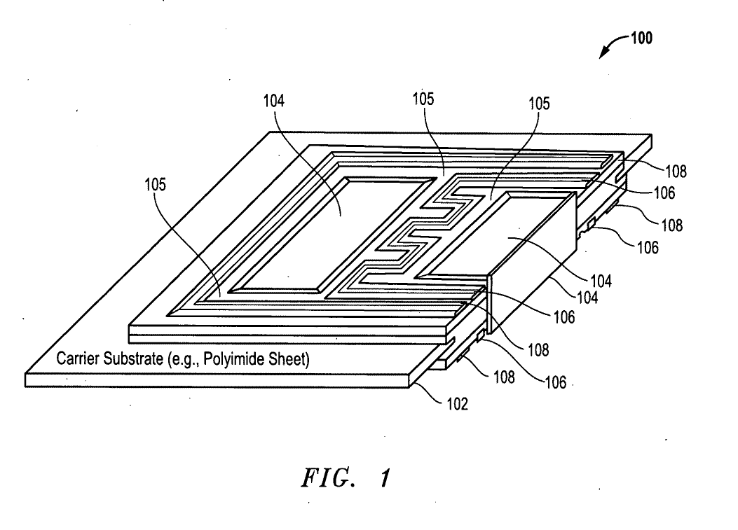

FIG. 1 illustrates a perspective cross-sectional view of a carrier substrate assembly 100 configured for production of a captured contact array according to one exemplary embodiment of the disclosed apparatus and methods. As shown, carrier substrate assembly includes a substantially planar carrier substrate (e.g., polyimide sheet, etc.) upon which metal contact pads 104 are disposed on each side. As shown, electrically conductive contact pads 104 disposed on a first (top) side of carrier substrate assembly 100 are electrically connected to contact pads 104 disposed on the second and opposing (bottom) side of carrier substrate assembly 100. Suitable materials for conductive contact pads 104 include, but are not limited to, metals such as platinum, etc.

Still referring to FIG. 1, carrier substrate assembly 100 also includes a built-in microheater filament 106 that is disposed adjacent contact pads 104 on each of the opposing first and second sides of carrier substrate assembly 100. A cold wall 108 is also disposed on each of first and second sides of carrier substrate assembly 100 around contact pads 104 and the respective microheater filament 106 that is on the same side of the carrier substrate assembly 100 in a manner that isolates contact pads 104 and microheater filament 106 (inside the cold wall 108) from the polyimide outer perimeter surrounding cold wall 108. A high temperature insulative material 105 (e.g., silicon oxide, silicon nitride, etc.) may be interposed between cold wall 108 and contact pads 104 and/or microheater filament 106 as shown. In the illustrated embodiment, each microheater filament 106 is configured to create the localized required temperatures (e.g., from about 750° C. to about 900° C.) for producing localized growth of CNT fibers or nanowires (e.g., on substrate assemblies having surrounding materials such as copper contacts, gold flashing, etc. that are exposed to the growing temperature), and the surrounding cold wall 108 is configured to provide thermal relief in order to prevent damage to the carrier substrate. However, it will be understood that localized temperatures for growing CNT fibers or nanowires may be selected to be appropriate for producing localized growth of CNT fibers or nanowires on carrier substrate assemblies having surrounding materials with different melting points. For example, temperatures of greater than about 900° C. may be employed for growing CNT fibers or nanowires in applications where the surrounding materials of the carrier substrate assembly 100 that are exposed to the CNT/nanowire growing temperature have higher melting points than copper or gold (e.g., such as platinum, silicon-based MEMs, etc.). Alternatively and in combination with cold walls, thermal isolation techniques achieved through micromachining may also be employed.

Fabrication, configuration and operation of microheater filaments 106 of FIG. 1 may be, for example, in accordance with microheaters described in Zhou, et al., Design and Fabrication of Microheaters for Localized Carbon Nanotube Growth, 8^{th} IEEE Conference on Nanotechnology, NANO 2008, pp. 452-455, 18-21 Aug. 2008, which is incorporated herein by reference in its entirety. Specifically, each of microheater filaments 106 may be suspended as a thin-film bridge or cantilevered structure over a cavity formed in the carrier substrate by surface micromachining, and with a contact to each opposing end of the filaments 106 for application of current for heating. Microheater filaments 106 may be constructed of any suitable electrically conductive material that is capable of withstanding the temperatures required to grow CNT or nanowire structures (e.g., platinum metal, etc.). In the case of platinum microheater filaments, a platinum heater layer may be sputtered and patterned by lift off process, and surrounding cavities formed by dry anisotropic etching. Cold wall 108 may be a thermally conductive material composed of gold, copper, etc., and fabricated by electroplating, deposition and etching, etc. Using this configuration, the cold wall 108 acts to absorb and carry away heat generated by the microheater filaments so that the suspended microheater filament and contacts 104 may be heated to a much higher temperature than the surrounding carrier substrate areas outside the cold wall 108, thus substantially preventing damage to surrounding components (polyimide sheet, transistor elements, etc.) of the carrier substrate 102. It will be understood that any other type of localized heating apparatus and/or methodology may be implemented to locally heat contacts 104, e.g., such as by employing laser directed energy onto contacts 104 using laser assisted growth methodology such as laser ablation.

In one exemplary embodiment, one or more thermally conductive probe/s may be connected to the cold wall to carry heat away off the substrate during CNT or nanowire growth. In another exemplary embodiment, a microelectromechanical (MEMs) temperature sensor may be fabricated on the carrier substrate assembly 100 in position to measure the applied CNT or nanowire growth temperature. This sensed growth temperature may be used to adjust and optimize heating temperatures during the CNT or nanowire growing process.

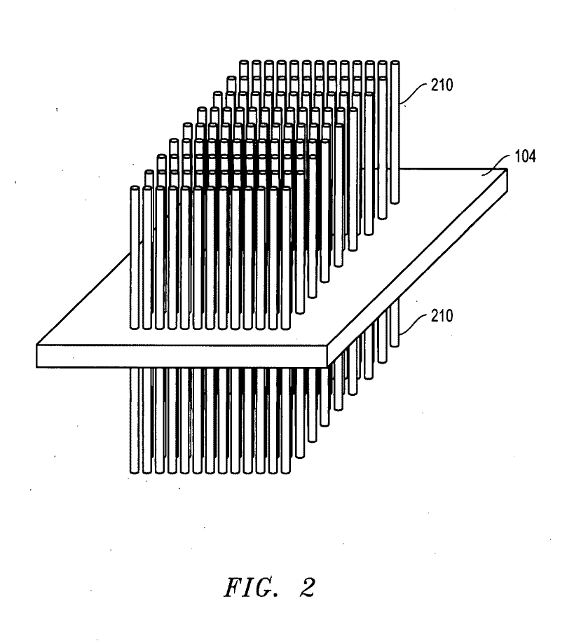

Forests of CNT fibers (or nanowires) may be locally grown on contact pads 104 of FIG. 1 to result in a captured contact array that includes flexible CNT (or nanowire) forests 210 grown on each of the opposing contact pads 104 of carrier substrate assembly 100 as shown in FIG. 2. To grow CNT forests, contact pads 104 may first be coated with a catalyst (e.g., nickel, cobalt, manganese, aluminum/iron based catalyst), for example, by drop-drying. A current source (e.g., voltage-controlled power source) may be coupled to each of the opposing ends of the microheater filaments 106 (e.g., via probes making contact with microheater filament contacts) to heat the contact pads 104 to sufficient CNT growth temperature (e.g., from about 750° C. to about 900° C.) while the contact pads 104 are exposed to a carbon source gas (e.g., CH₄, C₂H₂, or a combination thereof) in a controlled environment for a period long enough to achieve CNT forests having sufficient length (e.g., from about 0.1 mm to about 0.5 mm in length) and density for the given application. In either case, the resulting flexible CNT (or nanowire) forests 210 are permanently attached to contact pads 104 in a solderless manner. Catalyst materials may be optionally removed later, e.g., chemically or mechanically (such as micro-polishing). For growing CNT forests, contact pads 104 may first be coated with a catalyst (e.g., nickel, cobalt, manganese, aluminum/iron based catalyst) in a manner similar to growing CNT fibers, and then similar heating methodology may be employed while the contact pads 104 are exposed to a source material suitable for growing the desired nanowire material, e.g., silicon source gas such as silane or disilane for growing silicon nanowires. Other examples of nanowire materials that may be grown include, but are not limited to, zinc oxide, manganese, titanium etc. For either growing CNT or nanowire materials, parts of a carrier substrate assembly 100 may be masked off to prevent exposure to source materials during the growth process. This masking may later be removed using standard processing.

It will be understood that CNT (or nanowires) may be grown using similar processing conditions but with any other form of localized heating technique. For example, laser or other focused energy radiation may be alternatively employed to heat a contact surface or contact pad to a temperature sufficient to grow CNT or nanowire forests thereupon (e.g., from about 750° C. to about 900° C.). In such an embodiment, the remainder of a device substrate may be protected from thermal damage using temperature control structures and techniques described elsewhere herein.

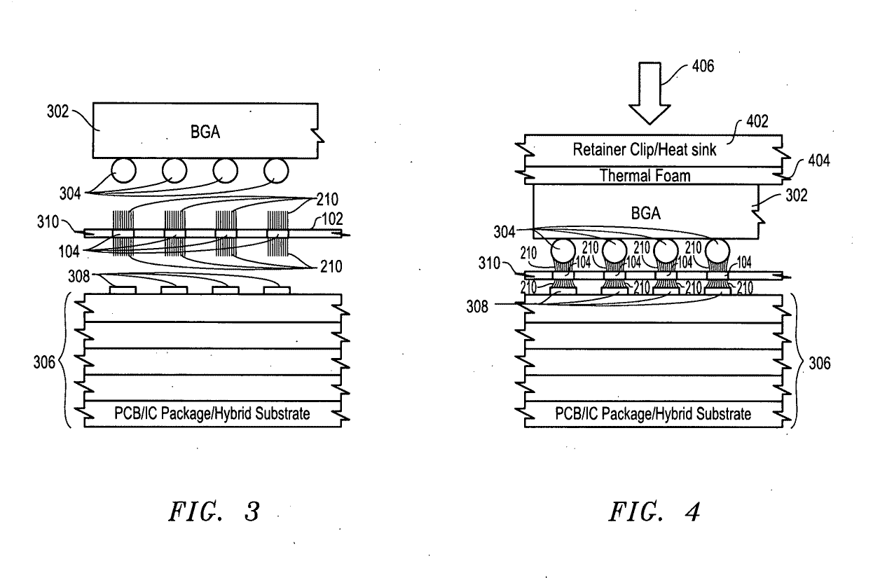

FIG. 3 illustrates a side cross sectional view of a captured contact array 310 as it may be positioned in one exemplary embodiment between a first device (e.g., a BGA package 302 having solder balls 304) and a second device 306 (e.g., PCB, IC package, hybrid multichip module substrate, etc.) having fixed contacts 308 in a BGA socket configuration, e.g., such as for a low insertion force or zero insertion force application.

Still referring to FIG. 3, CNT (or nanowire) forests 210 grown on contact pads 104 of captured contact array 310 are positioned in alignment with solder balls 304 and fixed contacts 308. FIG. 4 shows the components of FIG. 3 as they may be assembled and mechanically constrained together with downward force 406 applied by a retainer clip/heat sink component 402 and thermal foam 404 positioned therebetween such that CNT (or nanowire) forests 210 of captured contact array 310 make mechanical and electrical contact with solder balls 304 and fixed contacts 308, establishing an electrical interconnection therebetween. The configuration of retainer clip/heat sink component 402 may be a spring loaded frame or clip, screw down retainer, etc. or other suitable configuration. The thermal foam 404 may be any suitable thermal foam material, e.g., such as is used for socketing parts.

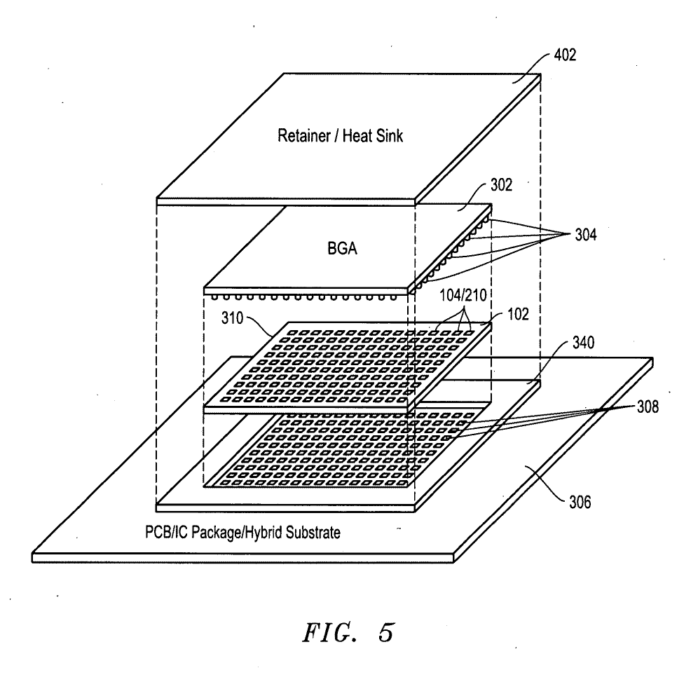

FIG. 5 shows an exploded perspective view of the components of FIG. 4, with socket wall 340 surrounding the area of fixed contacts 308 on second device 306 to form a socket thereon. As shown, socket wall 340 is configured to receive outer dimensions of carrier substrate 102 such that carrier substrate 102 is received within socket wall 308 with retainer/heat sink disposed thereon to hold carrier substrate 102 in place within socket wall 308.

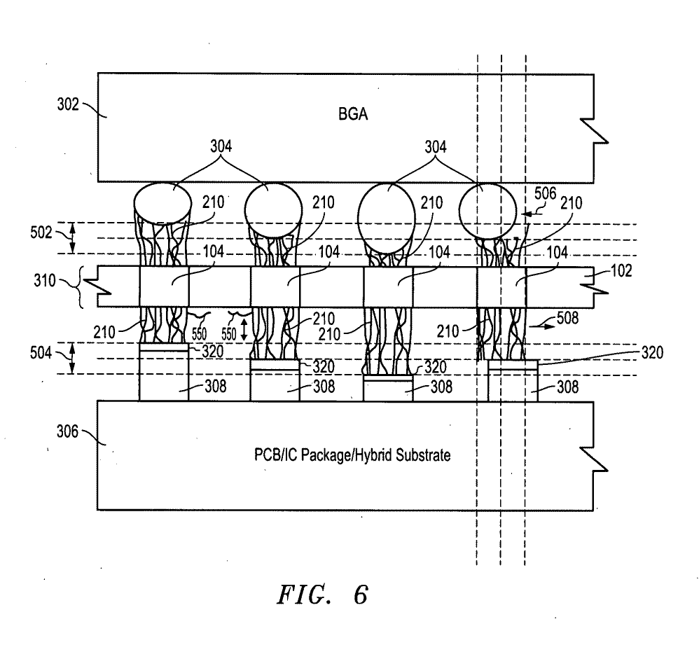

FIG. 6 illustrates an enlarged view of captured contact array 310 as it may be positioned in one exemplary embodiment between first device 302 and second device 306 of FIG. 3 to create solderless interconnections, e.g., such as for a low insertion force or zero insertion force application. In particular, FIG. 6 illustrates how CNT (or nanowire) forests 210 create flexible contacts that are capable of adjusting to compensate for mismatches in CTE and variations in diameter and/or size of solder balls 304 of BGA device 302, e.g., as represented by the dimensional tolerance shown by arrow 502 in FIG. 6. FIG. 6 also illustrates how CNT (or nanowire) forests 210 create flexible contacts that are capable of adjusting to compensate for mismatches in CTE, as well as variations in thickness of fixed contacts 308 and/or contact plating 320 of second device 306 as represented by the dimensional tolerance shown by arrow 504 in FIG. 6. Moreover, individual fibers of CNT (or nanowire) forests 210 may be grown to a length that is less than one half the distance between adjacent contact pads 104 to prevent shorting between adjacent contact pads 104 when bent over, as shown by bent over individual fibers 550 of FIG. 6. FIG. 6 also illustrates how individual fibers of CNT (or nanowire) forests 210 provide redundant connectivity that compensates for any error in horizontal alignment between contact pads 104 and solder balls 304 or contact pads 104 and fixed contacts 308 as shown by arrows 506 and 508, respectively. Additionally, material of carrier substrate 102 may be sufficiently flexible (i.e., polyimide film, flexible PCB, etc.) to account for mismatches in CTE and to flex so as to allow CNT (or nanowire) forests 210 to be vertical displaced for electrical connection.

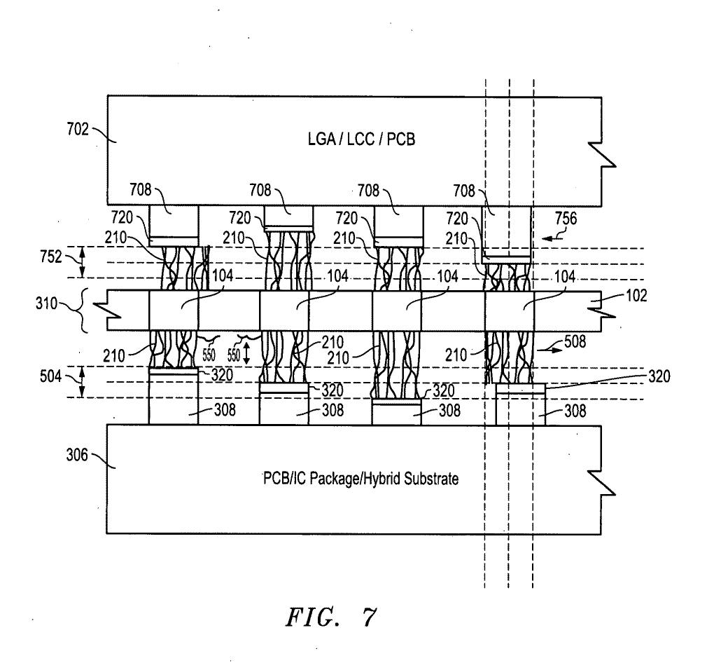

FIG. 7 illustrates an enlarged view of captured contact array 310 as it may be positioned in another exemplary embodiment between a first device 702 and second device 306 in a land grid array (LGA) or leadless chip carrier (LCC) package socket configuration, e.g., such as for a low insertion force or zero insertion force application. In this illustrated embodiment first device 702 may be configured as LGA or LCC package device. In a manner similar to that described in relation to FIGS. 4 and 5, components of FIG. 7 may be assembled and mechanically constrained together with downward force applied by a retainer clip/heat sink component and thermal foam positioned therebetween such that CNT (or nanowire) forests 210 of captured contact array 310 make mechanical and electrical contact with fixed contacts 308 and 708, establishing an electrical interconnection therebetween. Similar to the BGA configuration of FIG. 6, FIG. 7 illustrates how CNT (or nanowire) forests 210 create flexible contacts that are capable of adjusting to compensate for mismatches in CTE and variations in thickness of LGA/LCC/PCB contacts 708 and associated contact plating 720, e.g., as represented by the dimensional tolerance shown by arrow 752 in FIG. 7. FIG. 7 also illustrates how individual fibers of CNT (or nanowire) forests 210 provide redundant connectivity that compensates for any error in horizontal alignment between contact pads 104 and LGA/LCC/PCB contacts 708, as shown by arrow 756.

FIG. 8 shows an exploded perspective view of an embodiment similar to FIG. 5, with the exception that a socket is provided for a first device that is an integrated circuit 802 with leads 806 in this exemplary embodiment, e.g., such as for a low insertion force or zero insertion force application. As shown, captured contact array 310 may be positioned between first device that is a integrated circuit 802 with leads 806 and a second device 306 (e.g., PCB, IC package, hybrid multichip module substrate, etc.) having fixed contacts 308. CNT (or nanowire) forests 210 grown on contact pads 104 of captured contact array 310 are positioned in alignment with leads 806 and fixed contacts 308 of this embodiment. The components of FIG. 8 may be assembled and mechanically constrained together with downward force applied by a retainer clip/heat sink component 402 in a similar manner to that previously described for the embodiment of FIGS. 3-6 such that CNT (or nanowire) forests 210 of captured contact array 310 make mechanical and electrical contact with leads 806 and fixed contacts 308, establishing an electrical interconnection therebetween. Similar to the BGA configuration of FIG. 6, CNT (or nanowire) forests 210 of FIG. 8 create flexible contacts that are capable of adjusting to compensate for mismatches in CTE and variations in size of thickness, plating, and position of IC leads 806. Moreover, individual fibers of CNT (or nanowire) forests 210 provide redundant connectivity that compensates for any error in horizontal alignment between contact pads 104 and fixed contacts 308, and between contact pads 104 and IC leads 806.

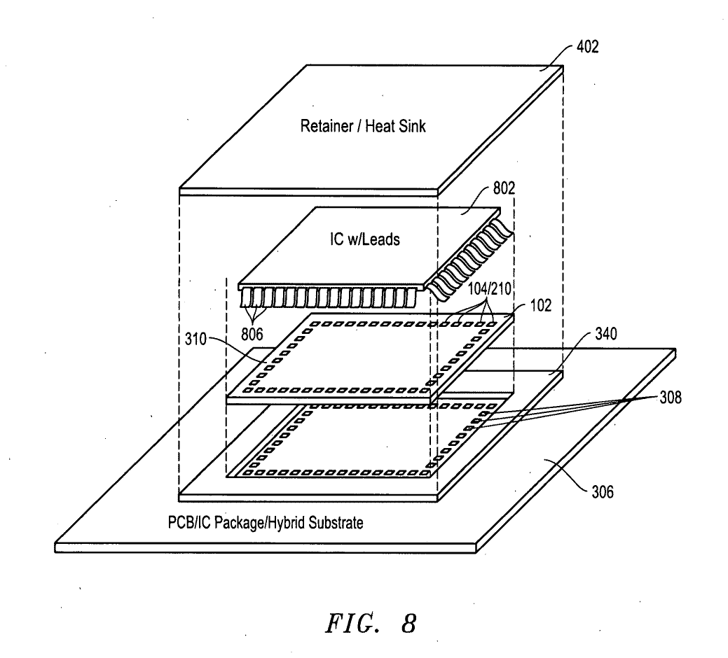

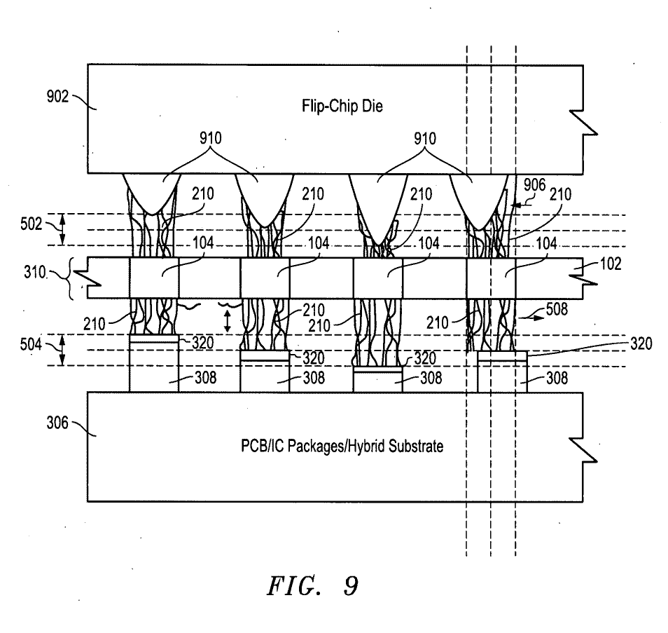

FIG. 9 shows an embodiment similar to FIG. 6, with the exception that a socket is provided for a first device that is a flip chip die 902 with solder bumps 910 in this exemplary embodiment, e.g., such as for a low insertion force or zero insertion force application. As shown, captured contact array 310 may be positioned between flip chip die 902 and a second device 306 (e.g., PCB, IC package, hybrid multichip module substrate, etc.) including external circuitry for interconnection with flip chip die 902 and having fixed contacts 308 in a flip chip socket configuration. CNT (or nanowire) forests 210 grown on contact pads 104 of captured contact array 310 are positioned in alignment with solder bumps 910 and fixed contacts 308 of this embodiment. The components of FIG. 9 may be assembled and mechanically constrained together with downward force applied by a retainer clip/heat sink component 402 in a similar manner to that previously described for the embodiment of FIGS. 3-6 such that CNT (or nanowire) forests 210 of captured contact array 310 make mechanical and electrical contact with solder bumps 910 and fixed contacts 308, establishing an electrical interconnection therebetween. Similar to the BGA configuration of FIG. 6, FIG. 9 illustrates how CNT (or nanowire) forests 210 create flexible contacts that are capable of adjusting to compensate for mismatches in CTE and variations in size of solder bumps 910 and fixed contacts 308 (and associated contact plating 320) of substrate assembly 306, e.g., as represented by the dimensional tolerance shown by arrows 902 and 504, respectively. FIG. 9 also illustrates how individual fibers of CNT (or nanowire) forests 210 provide redundant connectivity that compensates for any error in horizontal alignment between contact pads 104 and fixed contacts 308, and between contact pads 104 and solder bumps 910, as shown by arrows 508 and 906.

FIG. 10 shows an embodiment similar to FIG. 7, with the exception that a socket is provided for a first device that is a bare die 1002 with contacts 1008 and associated contact plating 1020 in this exemplary embodiment, e.g., such as for a low insertion force or zero insertion force application. As shown, captured contact array 310 may be positioned between bare die 1002 and second device 306 in a bare die socket configuration. CNT (or nanowire) forests 210 grown on contact pads 104 of captured contact array 310 are positioned in alignment with contacts 1008 and fixed contacts 308 of this embodiment. The components of FIG. 10 may be assembled and mechanically constrained together with downward force applied by a retainer clip/heat sink component 402 in a similar manner to that previously described for the embodiment of FIGS. 3-6 such that CNT (or nanowire) forests 210 of captured contact array 310 make mechanical and electrical contact with contacts 1008 and fixed contacts 308, establishing an electrical interconnection therebetween. Similar to the BGA configuration of FIG. 6, FIG. 10 illustrates how CNT (or nanowire) forests 210 create flexible contacts that are capable of adjusting to compensate for mismatches in CTE and variations in thickness of bare die contacts 1008 and associated contact plating 1002, e.g., as represented by the dimensional tolerance shown by arrow 1052 in FIG. 10. FIG. 10 also illustrates how individual fibers of CNT (or nanowire) forests 210 provide redundant connectivity that compensates for any error in horizontal alignment between contact pads 104 and fixed contacts 308, and between contact pads 104 and bare die contacts 1008, as shown by arrows 508 and 1056.

FIG. 11 illustrates a partial perspective view of a substrate assembly 306 (e.g., an integrated circuit die, multi-layer PCB assembly, stacked hybrid multichip module die substrate, etc.) according to one exemplary embodiment that includes at least one contact pad 308 disposed on a surface thereof, it being understood that multiple such contact pads 308 may be similarly disposed on substrate assembly 306. Substrate assembly 306 may also include integrated circuitry that is coupled to each contact 308, e.g., substrate assembly 802 may be a microprocessor or CPU, or a PCB with integrated circuitry contained therein or thereon, etc. As shown, substrate assembly 306 includes built-in microheater filament 1106 that is built into each contact pad 308. A cold wall 1108 is disposed around each contact pad 308 and its respective microheater filament 1106. In the illustrated embodiment, each microheater filament 1106 is configured to create the required temperatures (e.g., from about 750° C. to about 900° C.) for producing localized growth of CNT or nanowires on contact 308, and the surrounding cold wall 1108 is configured to provide thermal relief in order to prevent damage to the remainder of the substrate assembly, e.g., integrated circuitry.

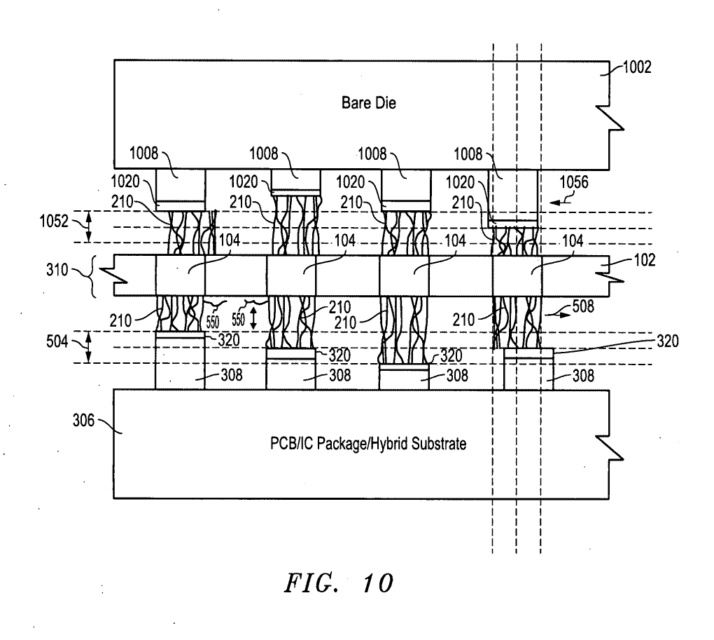

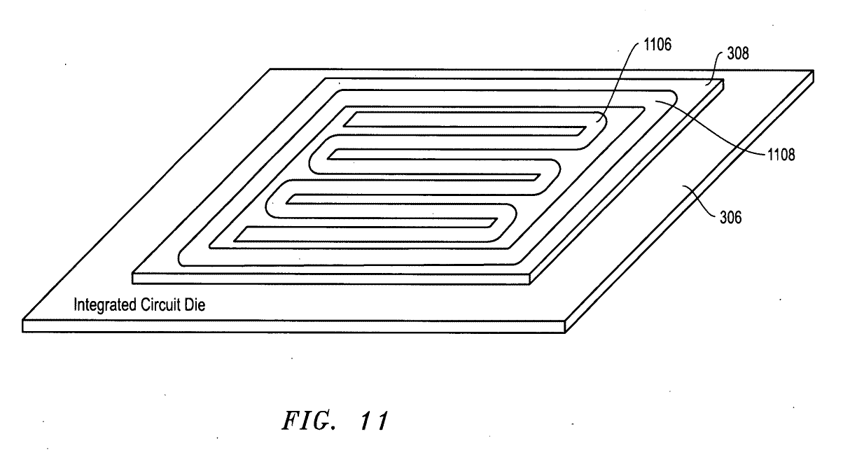

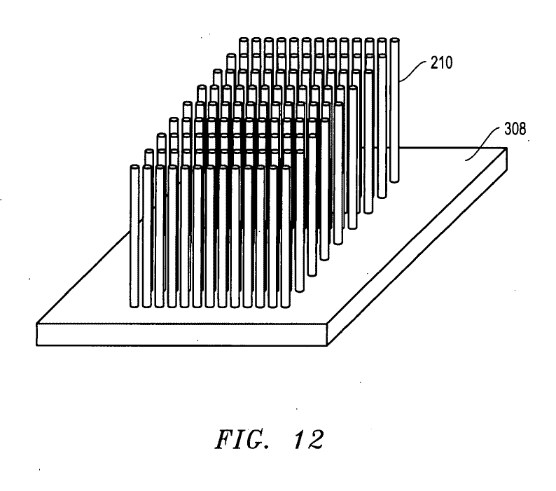

Fabrication, configuration and operation of microheater filaments 1106 of FIG. 11 may be, for example, the same as that described in relation to microheater filaments 106 of FIG. 1 so that the microheater filaments and contact 308 may be heated to a much higher temperature than the surrounding carrier substrate areas outside the cold wall 1108, thus substantially preventing damage to surrounding components and/or circuitry of the substrate assembly 306. As previously described in relation to contact pads 104 of FIGS. 1 and 2, CNT (or nanowire) forests may be locally grown on contact pads 308 of FIG. 11 to result in flexible CNT (or nanowire) forests 210 grown on each of contact pads 308 of substrate assembly 306 as shown in FIG. 12. Growth of CNT and nanowire forests on contact pads 308 may be accomplished using processing as previously described in relation to FIGS. 1 and 2.

FIG. 13 illustrates a side cross sectional view of a first device (e.g., a BGA package 302 having solder balls 304) as it may be positioned in one exemplary embodiment adjacent substrate assembly device 306 (e.g., PCB, IC package, hybrid multichip module substrate, etc.) having fixed contacts 308 in a BGA socket configuration, e.g., such as for a low insertion force or zero insertion force application.

As shown in FIG. 13, CNT (or nanowire) forests 210 grown on contact pads 308 of substrate assembly device 306 are positioned in alignment with solder balls 304. FIG. 4 shows the components of FIG. 3 as they may be assembled and mechanically constrained together with downward force 406 applied by a retainer clip/heat sink component 402 and thermal foam 404 positioned therebetween such that CNT (or nanowire) forests 210 of substrate assembly device 306 make mechanical and electrical contact with solder balls 304 of BGA package 302, establishing an electrical interconnection therebetween. The configuration of retainer clip/heat sink component 402 and thermal foam 404 may the same as previously descried in relation to FIG. 4.

FIG. 15 shows an exploded perspective view of the components of FIG. 4, with socket wall 340 surrounding the area of fixed contacts 308 on substrate assembly device 306 to form a socket thereon. As shown, socket wall 340 is configured to receive outer dimensions of BGA package 302 such that BGA package 302 is received within socket wall 308 with retainer/heat sink disposed thereon to hold BGA package 302 in place within socket wall 308.

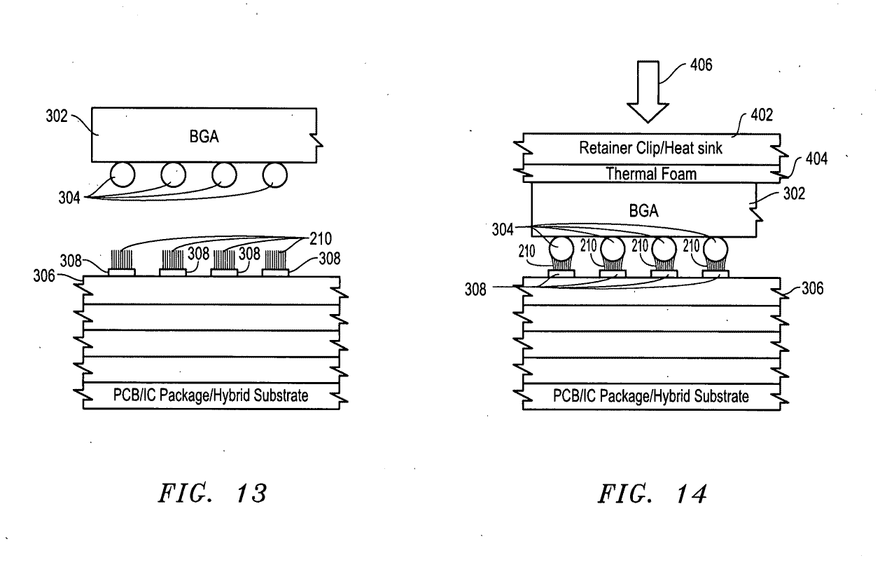

FIG. 16 illustrates an enlarged view of BGA package 302 as it may be positioned in one exemplary embodiment adjacent substrate assembly device 306 of FIG. 13 to create solderless interconnections, e.g., such as for a low insertion force or zero insertion force application. In particular, FIG. 16 illustrates how CNT (or nanowire) forests 210 create flexible contacts that are capable of adjusting to compensate for mismatches in CTE and variations in diameter and/or size of solder balls 304 of BGA device 302, e.g., as represented by the dimensional tolerance shown by arrow 502 in FIG. 16. FIG. 16 also illustrates how CNT (or nanowire) forests 210 create flexible contacts that are capable of adjusting to compensate for mismatches in CTE, as well as variations in thickness of fixed contacts 308 and/or contact plating 320 of substrate assembly device 306 as represented by the dimensional tolerance shown by arrow 504 in FIG. 16. As in other embodiments, individual fibers of CNT (or nanowire) forests 210 may be grown to a length that is less than one half the distance between adjacent contact pads 308 to prevent shorting between adjacent contact pads 308 when bent over. FIG. 16 also illustrates how individual fibers of CNT (or nanowire) forests 210 provide redundant connectivity that compensates for any error in horizontal alignment between contact pads 308 and solder balls 304 as shown by arrows 508 and 506, respectively.

FIG. 17 illustrates an enlarged view of a first device 1702 and substrate assembly device 306 in a land grid array (LGA) or leadless chip carrier (LCC) package socket configuration, e.g., such as for a low insertion force or zero insertion force application. In this illustrated embodiment first device 1702 may be configured as LGA or LCC package device. In a manner similar to that described in relation to FIGS. 4 and 5, components of FIG. 17 may be assembled and mechanically constrained together with downward force applied by a retainer clip/heat sink component and thermal foam positioned therebetween such that CNT (or nanowire) forests 210 of substrate assembly device 306 make mechanical and electrical contact with LGA/LCC/PCB contacts 1708, establishing an electrical interconnection therebetween. Similar to the BGA configuration of FIG. 16, FIG. 17 illustrates how CNT (or nanowire) forests 210 create flexible contacts that are capable of adjusting to compensate for mismatches in CTE and variations in thickness of LGA/LCC/PCB 1708 and associated contact plating 1720, e.g., as represented by the dimensional tolerance shown by arrow 1752 in FIG. 17. FIG. 17 also illustrates how individual fibers of CNT (or nanowire) forests 210 provide redundant connectivity that compensates for any error in horizontal alignment between fixed contacts 308 and LGA/LCC/PCB contacts 1708, as shown by arrows 508 and 1756.

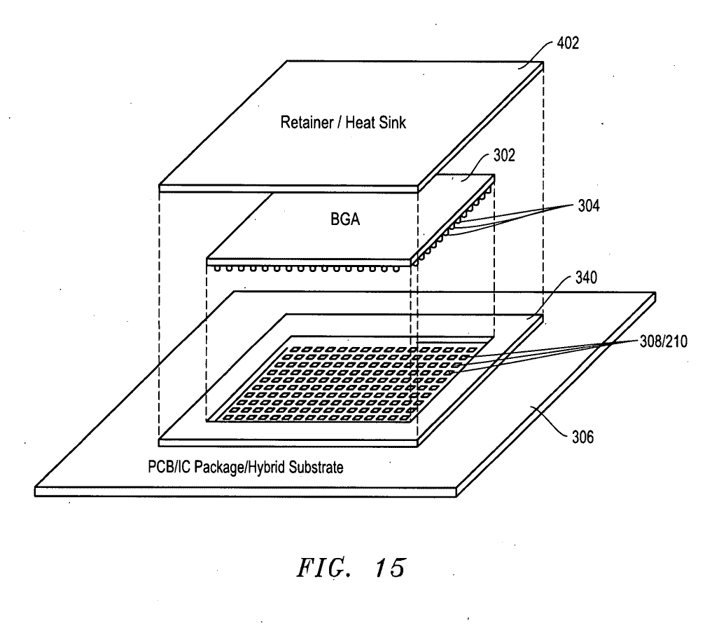

FIG. 18 shows an exploded perspective view of an embodiment similar to FIG. 15, with the exception that a socket is provided for a first device that is an integrated circuit 802 with leads 806 in this exemplary embodiment, e.g., such as for a low insertion force or zero insertion force application. As shown, a first device that is a integrated circuit with leads 806 may be positioned above and adjacent substrate assembly device 306 (e.g., PCB, IC package, hybrid multichip module substrate, etc.) having fixed contacts 308 in an IC socket configuration. CNT (or nanowire) forests 210 grown on contact pads 308 of substrate assembly device 306 are positioned in alignment with leads 806 of this embodiment. The components of FIG. 18 may be assembled and mechanically constrained together with downward force applied by a retainer clip/heat sink component 402 in a similar manner to that previously described for the embodiment of FIGS. 13-16 such that CNT (or nanowire) forests 210 of substrate assembly device 306 make mechanical and electrical contact with leads 806 of integrated circuit 802, establishing an electrical interconnection therebetween. Similar to the BGA configuration of FIG. 16, CNT (or nanowire) forests 210 of FIG. 18 create flexible contacts that are capable of adjusting to compensate for mismatches in CTE and variations in size of thickness, plating, and position of IC leads 806. Moreover, individual fibers of CNT (or nanowire) forests 210 provide redundant connectivity that compensates for any error in horizontal alignment between fixed contacts 308 IC leads 806.

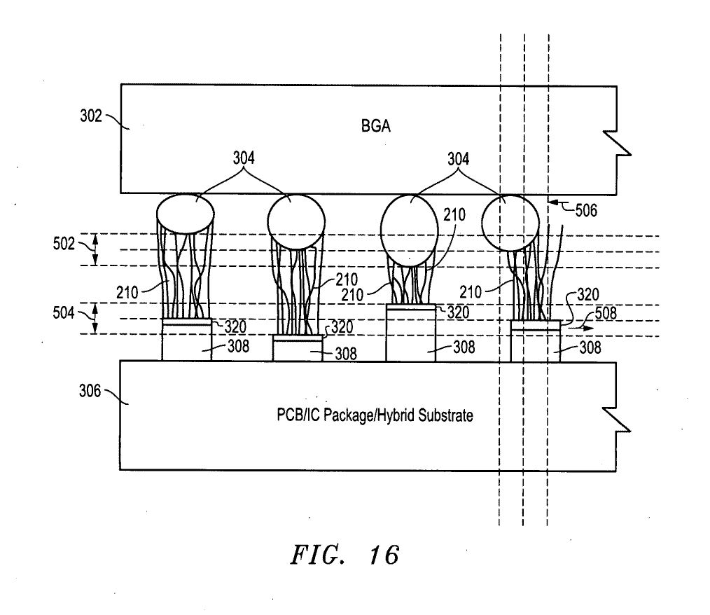

FIG. 19 shows an embodiment similar to FIG. 16, with the exception that a socket is provided for a first device that is a flip chip die 902 with solder bumps 910 in this exemplary embodiment, e.g., such as for a low insertion force or zero insertion force application. As shown, a first device that is a flip chip die 902 may be positioned above and adjacent substrate assembly device 306 (e.g., PCB, IC package, hybrid multichip module substrate, etc.) having fixed contacts 308 in a flip chip die socket configuration. In this embodiment, substrate assembly device 306 may include external circuitry for interconnection with flip chip die 902. CNT (or nanowire) forests 210 grown on contact pads 308 of substrate assembly device 306 are positioned in alignment with solder bumps 910 of this embodiment. The components of FIG. 19 may be assembled and mechanically constrained together with downward force applied by a retainer clip/heat sink component 402 in a similar manner to that previously described for the embodiment of FIGS. 13-16 such that CNT (or nanowire) forests 210 of captured contact array 310 make mechanical and electrical contact with solder bumps 910 of flip chip die 902, establishing an electrical interconnection therebetween. Similar to the BGA configuration of FIG. 16, FIG. 19 illustrates how CNT (or nanowire) forests 210 create flexible contacts that are capable of adjusting to compensate for mismatches in CTE and variations in size of solder bumps 910 and fixed contacts 308 (and associated contact plating 320) of substrate assembly 306, e.g., as represented by the dimensional tolerance shown by arrows 902 and 504, respectively. FIG. 19 also illustrates how individual fibers of CNT (or nanowire) forests 210 provide redundant connectivity that compensates for any error in horizontal alignment between fixed contacts 308 and solder bumps 910, as shown by arrows 508 and 906.

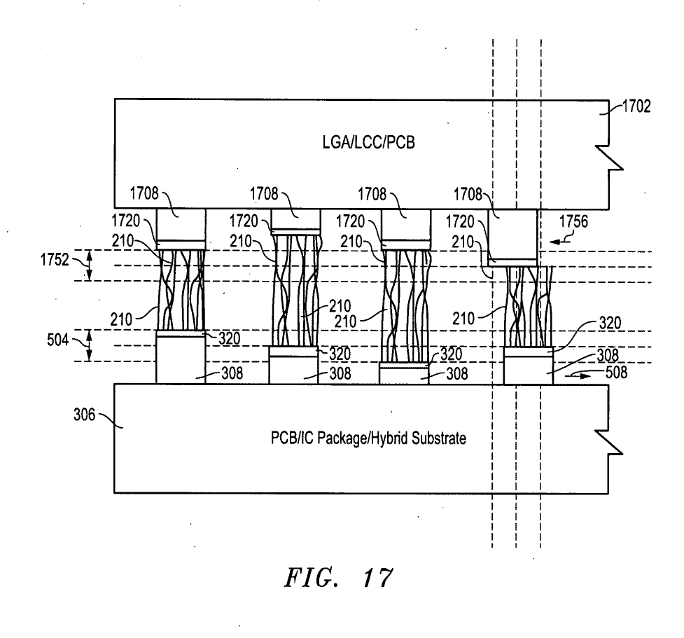

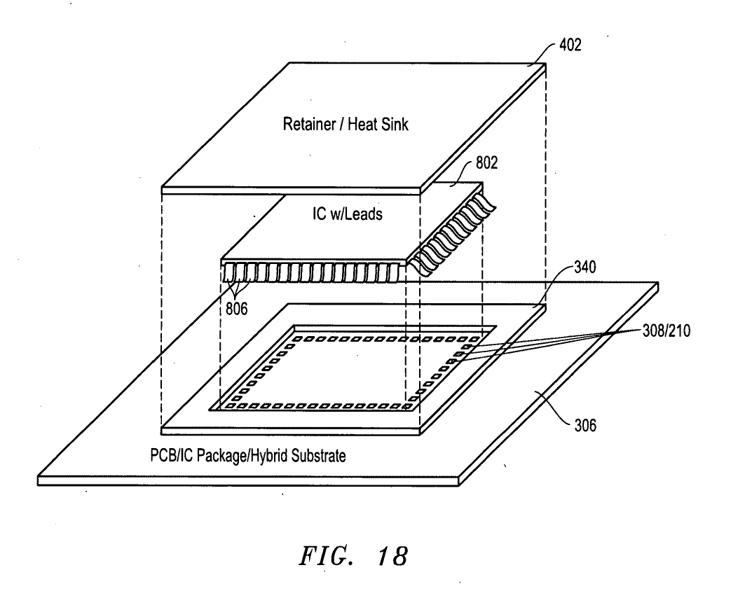

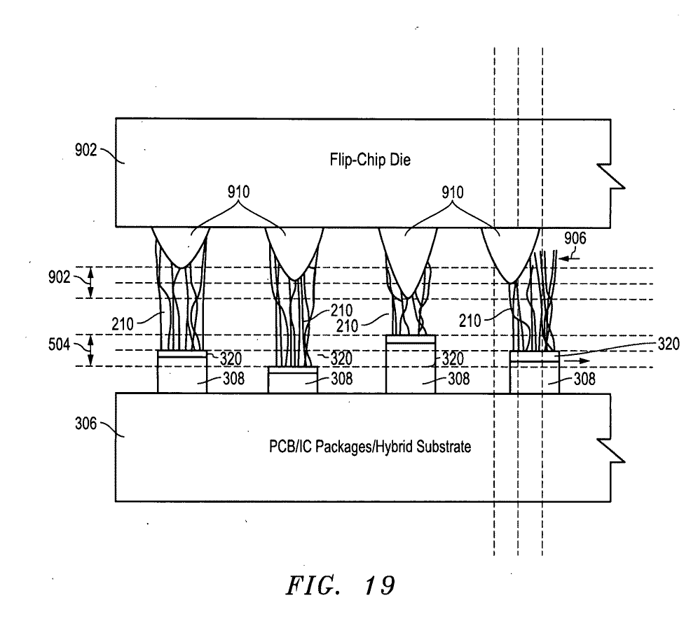

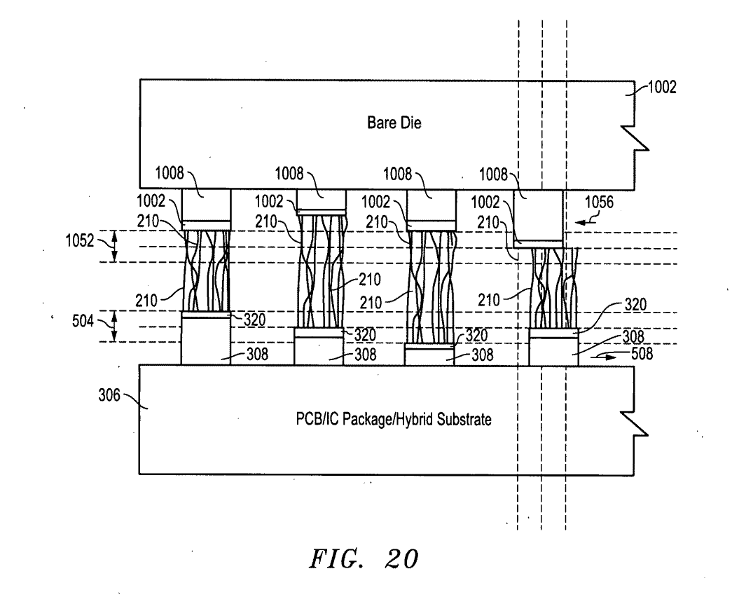

FIG. 20 shows an embodiment similar to FIG. 17, with the exception that a socket is provided for a first device that is a bare die 1002 with contacts 1008 and associated contact plating 1020 in this exemplary embodiment, e.g., such as for a low insertion force or zero insertion force application. As shown, bare die 1002 may be positioned above and adjacent substrate assembly device 306 (e.g., PCB, IC package, hybrid multichip module substrate, etc.) in a bare die socket configuration. CNT (or nanowire) forests 210 grown on contact pads 308 of substrate assembly device 306 are positioned in alignment with contacts 1008 of this embodiment. The components of FIG. 20 may be assembled and mechanically constrained together with downward force applied by a retainer clip/heat sink component 402 in a similar manner to that previously described for the embodiment of FIGS. 13-16 such that CNT (or nanowire) forests 210 of substrate assembly device 306 make mechanical and electrical contact with contacts 1008 of bare die 1002, establishing an electrical interconnection therebetween. Similar to the BGA configuration of FIG. 16, FIG. 20 illustrates how CNT (or nanowire) forests 210 create flexible contacts that are capable of adjusting to compensate for mismatches in CTE and variations in thickness of bare die contacts 1008 and associated contact plating 1002, e.g., as represented by the dimensional tolerance shown by arrow 1052 in FIG. 20. FIG. 20 also illustrates how individual fibers of CNT (or nanowire) forests 210 provide redundant connectivity that compensates for any error in horizontal alignment between fixed contacts 308 and bare die contacts 1008, as shown by arrows 508 and 1056.

With regard to FIG. 20, it will be understood that CNT (or nanowire) forests 210 may alternatively be grown directly on contacts 1008 of bare die 1002 instead of being grown on fixed contacts 308 of substrate assembly device 306. In such an alternate case, bare die 1002 may be positioned above and adjacent substrate assembly device 306 with contact pads 308 of substrate assembly device 306 positioned in alignment with contacts 1008 for assembly in a similar manner.

FIG. 21 shows an exploded perspective view of an exemplary embodiment similar to FIG. 20, with the exception that a socket is provided for multiple bare die devices (e.g., first bare die 1002 and second bare die 2102 in this example) with contact pads 1008 thereon, e.g., such as for a low insertion force or zero insertion force application. As shown, second bare die 2102 may be positioned between first bare die 1002 and substrate assembly device 306 (e.g., PCB, IC package, hybrid multichip module substrate, etc.) having fixed contacts 308 in a stacked bare die socket configuration. In one exemplary configuration, CNT (or nanowire) forests 210 may be grown directly on die contact pads 1008 of second bare die 2102, and positioned in alignment with underlying fixed contacts 308 of substrate assembly device 306 and overlying contact pads 1008 of first bare die 1002, as shown in FIG. 21. The components of FIG. 21 may be assembled and mechanically constrained together with downward force applied by a retainer clip/heat sink component 402 in a similar manner to that previously described for the embodiment of FIGS. 13-16 such that CNT (or nanowire) forests 210 of second bare die 2102 make mechanical and electrical contact with underlying fixed contacts 308 of substrate assembly device 306 and overlying contact pads 1008 of first bare die 1002, establishing an electrical interconnection therebetween. Similar to the BGA configuration of FIG. 16, CNT (or nanowire) forests 210 create flexible contacts that are capable of adjusting to compensate for mismatches in CTE and variations in thickness of bare die contacts 1008 and associated contact plating 1002, and to provide redundant connectivity that compensates for any error in horizontal alignment between fixed contacts 308 and bare die contacts 1008.

With regard to FIG. 21, it will be understood that CNT (or nanowire) forests 210 may alternatively be grown directly on contact pads 1008 of first bare die 1002 (i.e., instead of being grown on upper contact pads 1008 of second bare die 2102) and/or CNT (or nanowire) forests 210 may alternatively be grown on fixed contacts 308 of substrate assembly device 306 (i.e., instead of being grown on lower contact pads 1008 of second bare die 2102). In such alternative cases, first bare die 1002 and second bare die 2102 may be aligned and positioned above and adjacent substrate assembly device 306 with contact pads 308 of substrate assembly device 306 for assembly in a similar manner in a bare die socket configuration.

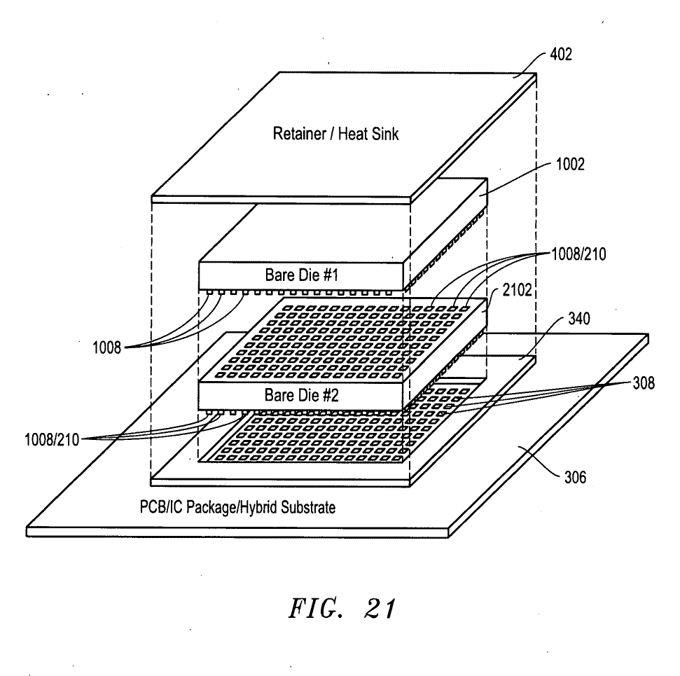

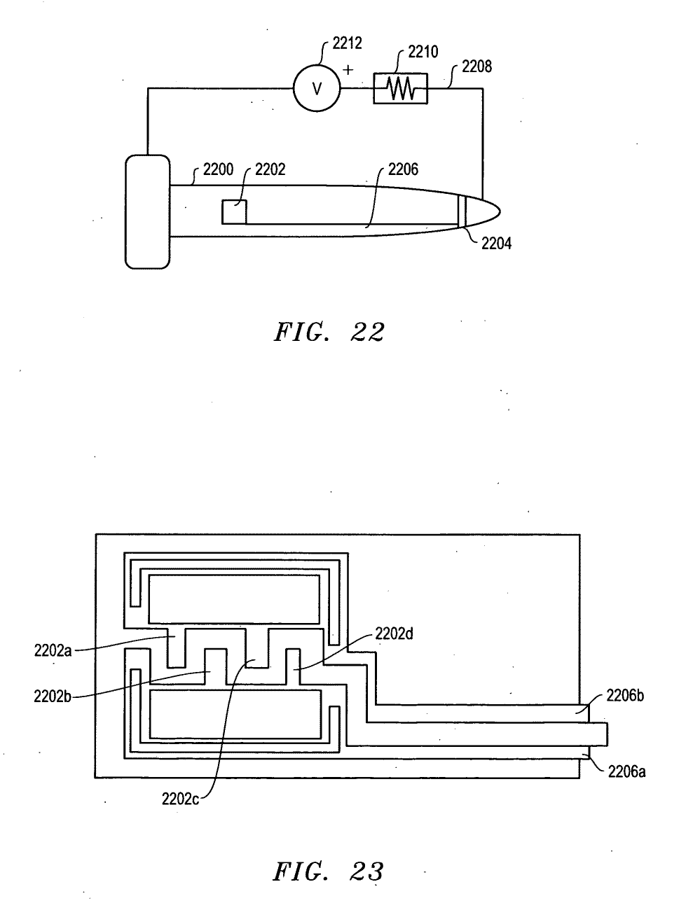

FIG. 22 illustrates another exemplary embodiment of the disclosed apparatus and methods in which CNT (or nanowire) forests 210 are grown on a conductive (e.g., metal) cylindrical connector pin 2200, it being understood that CNT (or nanowire) forests 210 may be grown on any other type of connector pin and/or corresponding connector receptacle, e.g., including non-cylindrical connector pins and receptacles. FIG. 22 illustrates an example heater pad 2202 that is coupled to an on-pin circuit trace 2206 for connection to an external circuit that includes a conductor 2208 that couples together a voltage-controlled current source 2212 and resistor 2210 in series. It will be understood that number and/or size of heater pads 2202 provided on a connector pin 2200 or other type of connector surface described herein may vary to fit each given application. Heater pad 2202 may be provided with a microheater filament configured as previously described herein. As shown in FIG. 22, the circuitry is coupled in this exemplary embodiment substantially across the length of connector pin 2200, and the on-pin circuit trace 2206 is coupled across connector pin insulator ring 2204 which separates ends of connector pin 2200. As previously described in relation to FIG. 2, heater pad 2202 may first be coated with appropriate catalyst and voltage-controlled current source 2212 may be coupled to each of the opposing ends of connector pin 2200 as shown in order to cause the microheater filament to heat heater pad 2202 to sufficient CNT (or nanowire) growth temperature while the heater pad 2202 is exposed to an appropriate precursor gas or gases for a period long enough to achieve CNT (or nanowire) forests 210 having sufficient length (e.g., a forest length of from about ½ A millimeter to about 3 millimeter although greater and lesser lengths are possible) and density for the given connector application. Similar methodology may be applied for growing CNT (or nanowire) forests 210 in each of the exemplary connector embodiments of FIGS. 22-49.

FIG. 23 illustrates surface of connector pin 2200 of FIG. 22, showing multiple heater pads 2200a, 2200b, 2200c and 2200d and corresponding on-pin circuit traces 2206a and 2206b that may be provided in one exemplary embodiment. The number and size of heater pads may be varied to create the desired geometry and size of CNT (or nanowire) forests 210 to fit a given application.

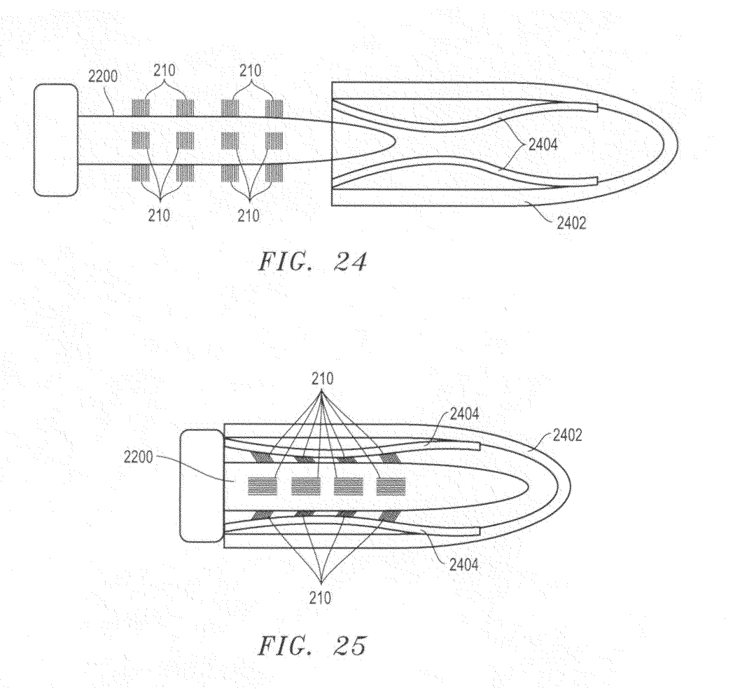

FIG. 24 illustrates a cylindrical connector pin 2200 with multiple CNT (or nanowire) forest segments 210 grown directly thereon in a solderless manner that is aligned and positioned for sliding insertion into a corresponding cylindrical connector receptacle 2402 that has opposing conductive (e.g., metal) connector springs 2404 according to one exemplary embodiment of the disclosed apparatus and methods. In such a configuration, each of connector pin 2200 and conductive (e.g., metal) connector springs 2404 may be coupled to corresponding separate circuitry. Connector springs 2404 are spaced apart within receptacle 2402 such that CNT (or nanowire) forest segments may be inserted therebetween in mechanical and electrical contact, but without connector springs 2404 contacting the body of connector pin 2200 as shown in FIG. 25.

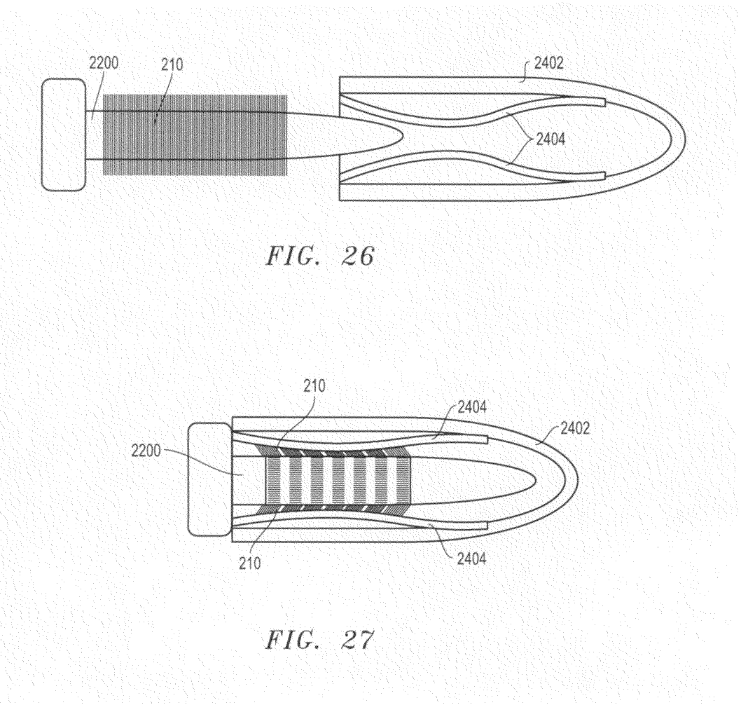

FIG. 26 illustrates a cylindrical connector pin 2200 with a single CNT (or nanowire) forest segment 210 grown directly thereon in a solderless manner around the periphery of connector pin 2200. In FIG. 26, connector pin 2200 and single CNT (or nanowire) forest segment 210 is aligned and positioned for insertion into a corresponding cylindrical connector receptacle 2402 that has connector springs 2404 according to one exemplary embodiment of the disclosed apparatus and methods. As with FIG. 25, connector springs 2404 are spaced apart within receptacle 2402 such that CNT (or nanowire) forest segment 210 may be slidingly inserted therebetween in mechanical and electrical contact, but without connector springs 2404 contacting the body of connector pin 2200 as shown in FIG. 27.

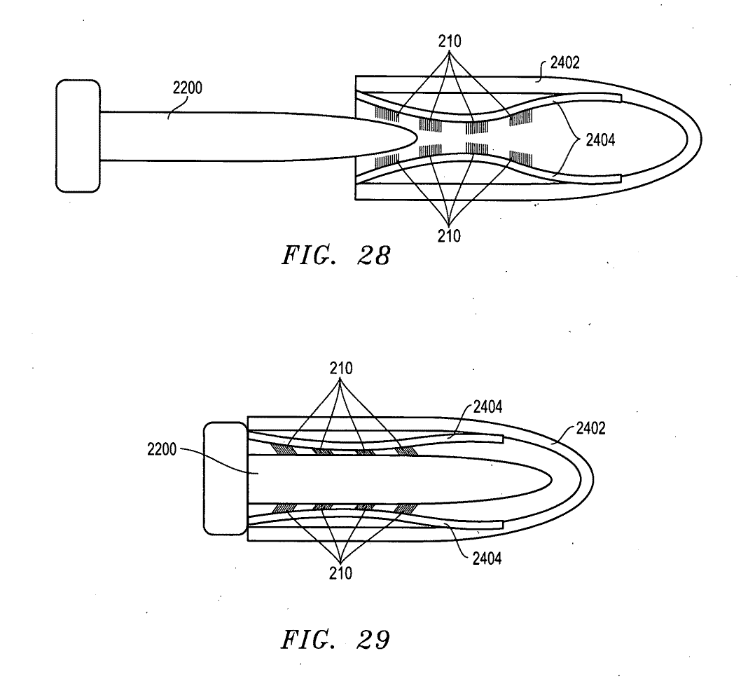

FIG. 28 illustrates a bare cylindrical connector pin 2200 that is aligned and positioned for insertion into a corresponding cylindrical connector receptacle 2402 that has opposing connector springs 2404 according to one exemplary embodiment of the disclosed apparatus and methods. In this exemplary embodiment, multiple CNT (or nanowire) forest segments 210 are grown directly on the opposing connector springs 2404 in a solderless manner, e.g., using heater pads that are provided on connector springs 2404 instead of connector pin 2200. As shown, connector springs 2404 are spaced apart within receptacle 2402 such that CNT (or nanowire) forest segments 210 may slidingly receive connector pin 2200 therebetween in mechanical and electrical contact, but without connector springs 2404 contacting the body of connector pin 2200 as shown in FIG. 29.

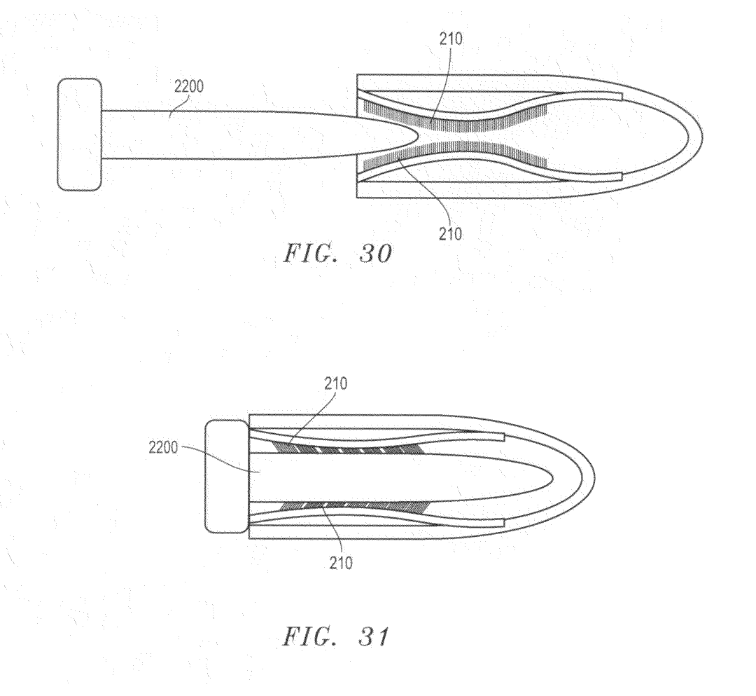

FIG. 30 illustrates a bare cylindrical connector pin 2200 that is aligned and positioned for insertion into a corresponding cylindrical connector receptacle 2402 that has opposing connector springs 2404 according to one exemplary embodiment of the disclosed apparatus and methods. In this exemplary embodiment, a single continuous CNT (or nanowire) forest segment 210 is grown directly on each of opposing connector springs 2404 in a solderless manner, e.g., using heater pads that are provided on connector springs 2404 instead of connector pin 2200. As shown, connector springs 2404 are spaced apart within receptacle 2402 such that CNT (or nanowire) forest segments 210 may slidingly receive connector pin 2200 therebetween in mechanical and electrical contact, but without connector springs 2404 contacting the body of connector pin 2200 as shown in FIG. 31.

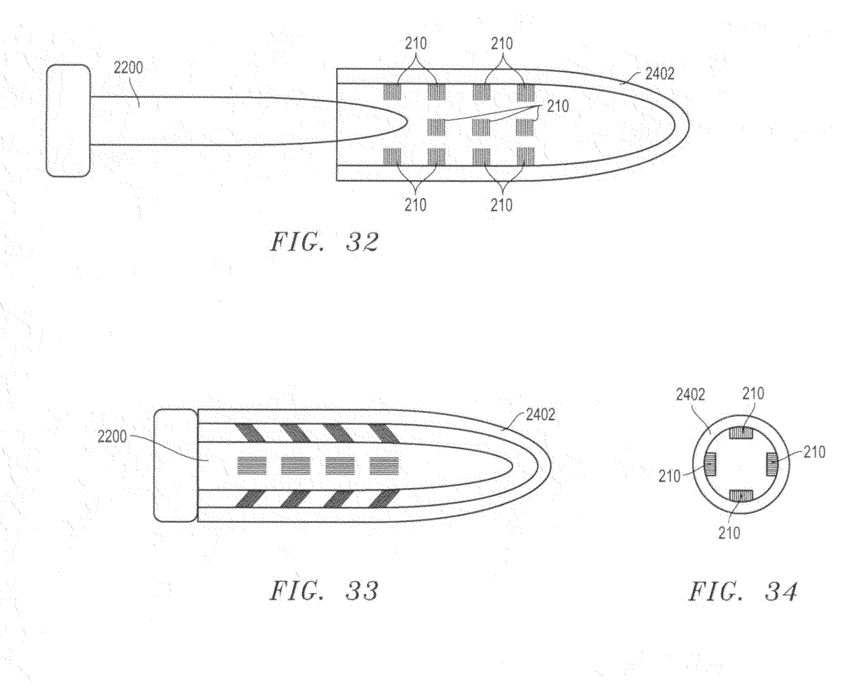

FIG. 32 illustrates a bare cylindrical connector pin 2200 that is aligned and positioned for insertion into a corresponding cylindrical connector receptacle 2402 that has no opposing connector springs therein according to one exemplary embodiment of the disclosed apparatus and methods. In this exemplary embodiment, multiple CNT (or nanowire) forest segments 210 are grown directly on the bare interior surface of connector receptacle 2402 in a solderless manner, e.g., using heater pads that are provided on interior surface of connector receptacle 2402 instead of connector pin 2200. As shown, CNT (or nanowire) forest segments 210 may slidingly receive connector pin 2200 therebetween in mechanical and electrical contact, but without bare interior surface of connector receptacle 2402 contacting the body of connector pin 2200 as shown in FIG. 33. FIG. 34 shows an end on view of multiple CNT (or nanowire) forest segments 210 as they may be provided within the interior of cylindrical connector receptacle 2402.

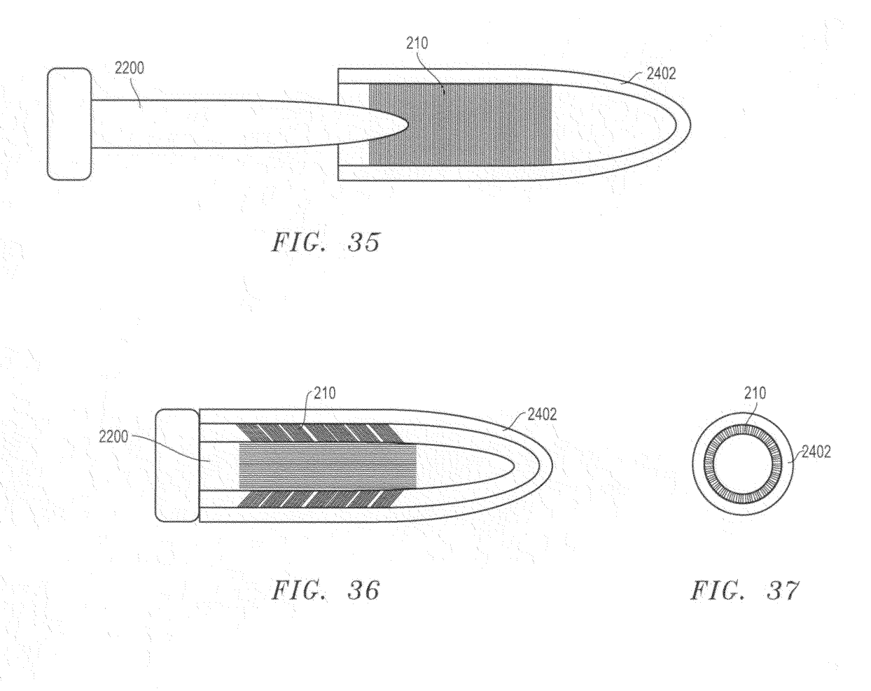

FIG. 35 illustrates a bare cylindrical connector pin 2200 that is aligned and positioned for insertion into a corresponding cylindrical connector receptacle 2402 that has no opposing connector springs therein according to one exemplary embodiment of the disclosed apparatus and methods. In this exemplary embodiment, a single continuous CNT (or nanowire) forest segment 210 is grown directly around the periphery of the bare interior surface of connector receptacle 2402 in a solderless manner, e.g., using heater pads that are provided on interior surface of connector receptacle 2402 instead of connector pin 2200. As shown, CNT (or nanowire) forest segments 210 may slidingly receive connector pin 2200 therebetween in mechanical and electrical contact, but without bare interior surface of connector receptacle 2402 contacting the body of connector pin 2200 as shown in FIG. 36. FIG. 37 shows an end on view of multiple CNT (or nanowire) forest segments 210 as they may be provided within the interior of cylindrical connector receptacle 2402.

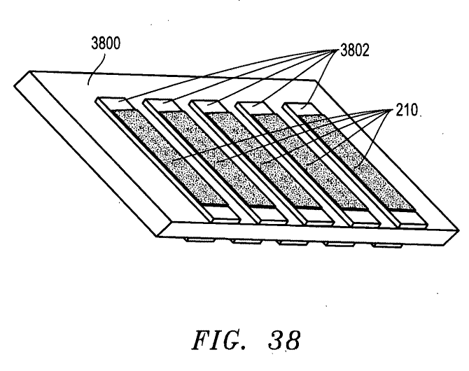

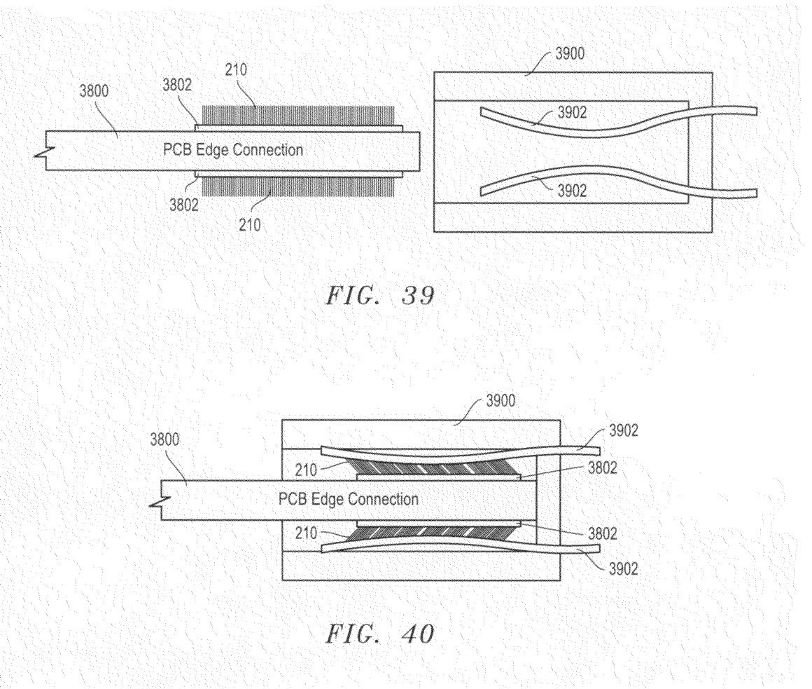

FIG. 38 illustrates a PCB card 3800 having conductive (e.g., metal) surface pads 3802 disposed thereon for edge (blade) connections. In this exemplary embodiment, a single continuous CNT (or nanowire) forest segment 210 is grown directly on each conductive surface pad 3802 in a solderless manner, e.g., using heater pads that are provided on the surface of each surface pad 3802. FIG. 39 illustrates PCB card 3800 of FIG. 38 aligned and positioned for insertion into a corresponding card edge connector 3900 that has opposing conductive (e.g., metal) spring contacts 3902 positioned therein. Each of conductive surface pads 3802 and spring contacts 3902 may be coupled to corresponding separate circuitry. In this exemplary embodiment, CNT (or nanowire) forest segments 210 may be slidingly received between opposing pairs of spring contacts 3902 in mechanical and electrical contact, but without surface of spring contacts 3902 contacting surface pads 3802 as shown in FIG. 40.

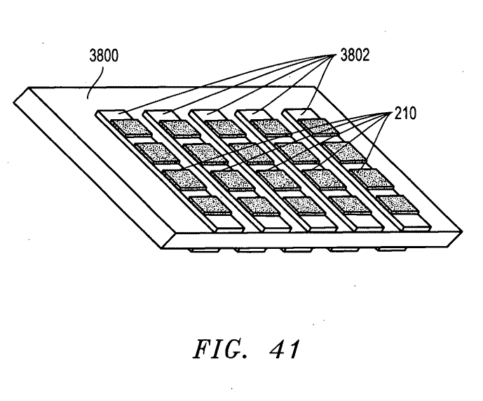

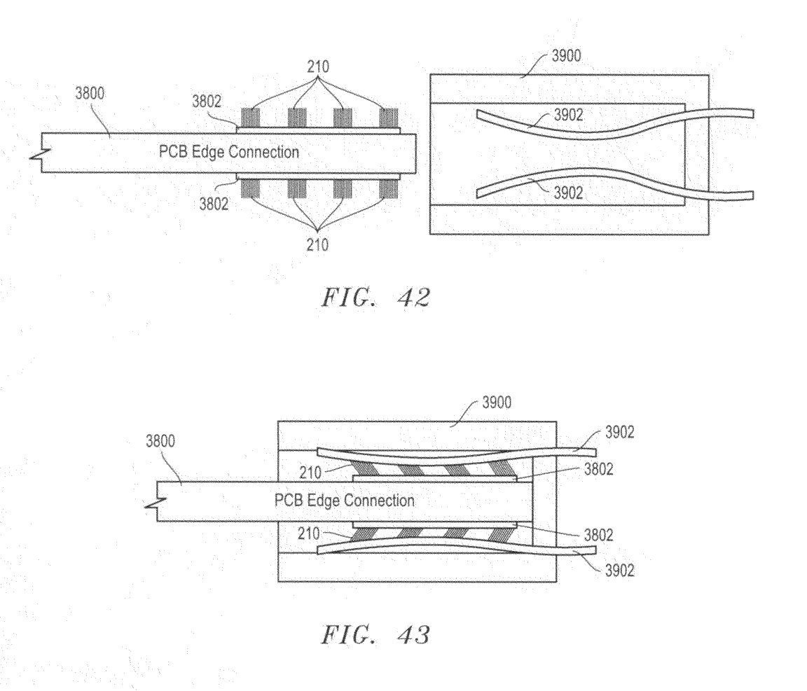

FIG. 41 illustrates a PCB card 3800 having conductive metal surface pads 3802 disposed thereon. In this exemplary embodiment, multiple CNT (or nanowire) forest segments 210 are grown directly on each conductive surface pad 3802 in a solderless manner, e.g., using heater pads that are provided on the surface of each surface pad 3802. FIG. 42 illustrates PCB card 3800 of FIG. 41 aligned and positioned for insertion into a corresponding card edge connector 3900 that has opposing spring contacts 3902 positioned therein. In this exemplary embodiment, CNT (or nanowire) forest segments 210 may be slidingly received between opposing pairs of spring contacts 3902 in mechanical and electrical contact, but without surface of spring contacts 3902 contacting surface pads 3802 as shown in FIG. 43.

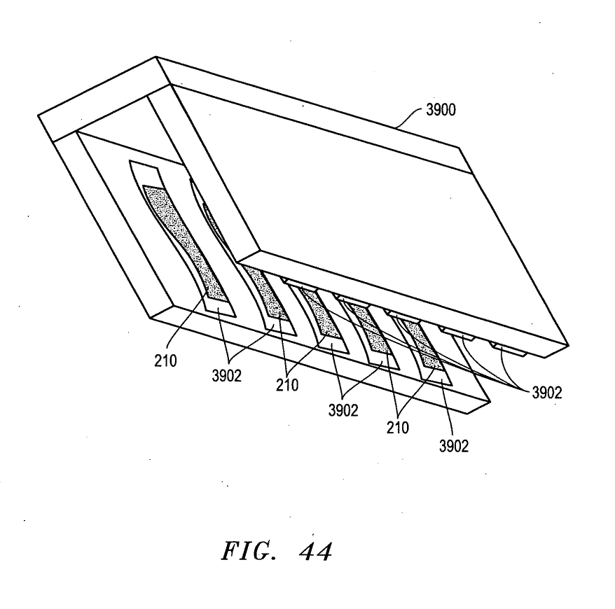

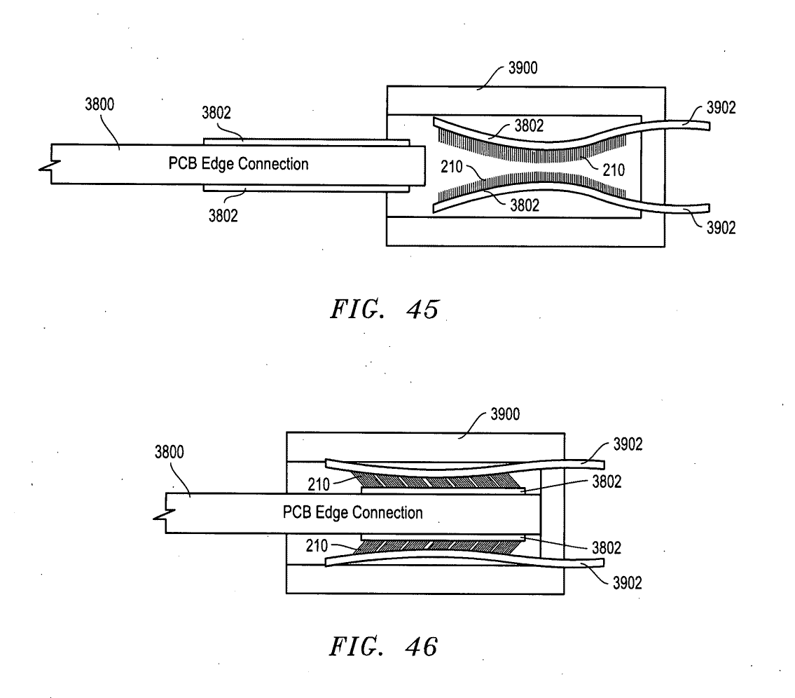

FIG. 44 shows a perspective view of a card connector 3900 having opposing pairs of spring contacts 3902 disposed therein. In this exemplary embodiment, a single continuous CNT (or nanowire) forest segment 210 is grown directly on each conductive spring contact 3902 in a solderless manner, e.g., using heater pads that are provided on the surface of each surface pad 3902. FIG. 45 illustrates a PCB card 3900 having conductive surface pads 3802 disposed thereon that is positioned for insertion into card edge connector 3900 of FIG. 44. In this exemplary embodiment, CNT (or nanowire) forest segments 210 of spring contacts 3902 may slidingly receive surface pads 3802 therebetween in mechanical and electrical contact, but without surface of spring contacts 3902 contacting surface pads 3802 as shown in FIG. 46.

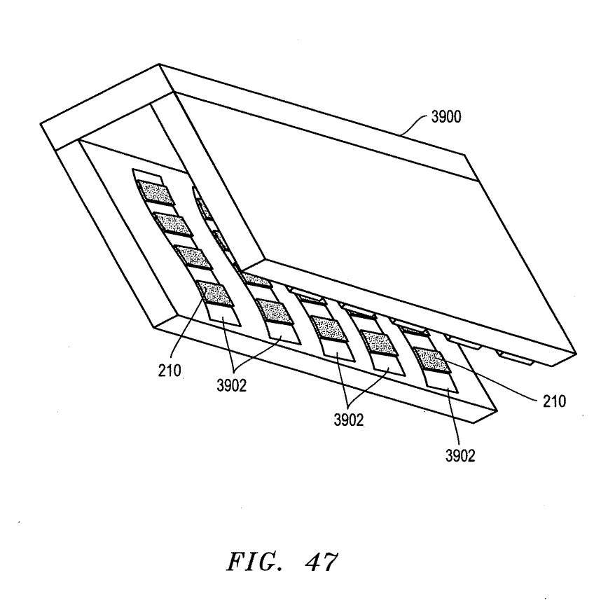

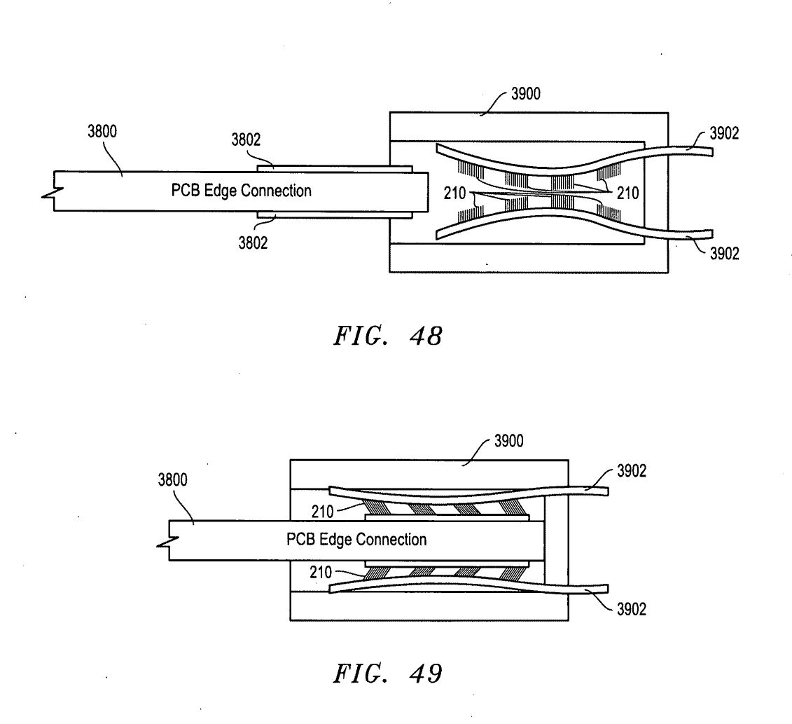

FIG. 47 shows a perspective view of a card edge connector 3900 having opposing pairs of spring contacts 3902 disposed therein. In this exemplary embodiment, multiple CNT (or nanowire) forest segments 210 are grown directly on each conductive spring contact 3902 in a solderless manner, e.g., using heater pads that are provided on the surface of each surface pad 3902. FIG. 48 illustrates a PCB card 3900 having conductive surface pads 3802 disposed thereon that is positioned for insertion into card edge connector 3900 of FIG. 44. In this exemplary embodiment, CNT (or nanowire) forest segments 210 of spring contact 3902 may slidingly receive surface pads 3802 therebetween in mechanical and electrical contact, but without surface of spring contacts 3902 contacting surface pads 3802 as shown in FIG. 49.

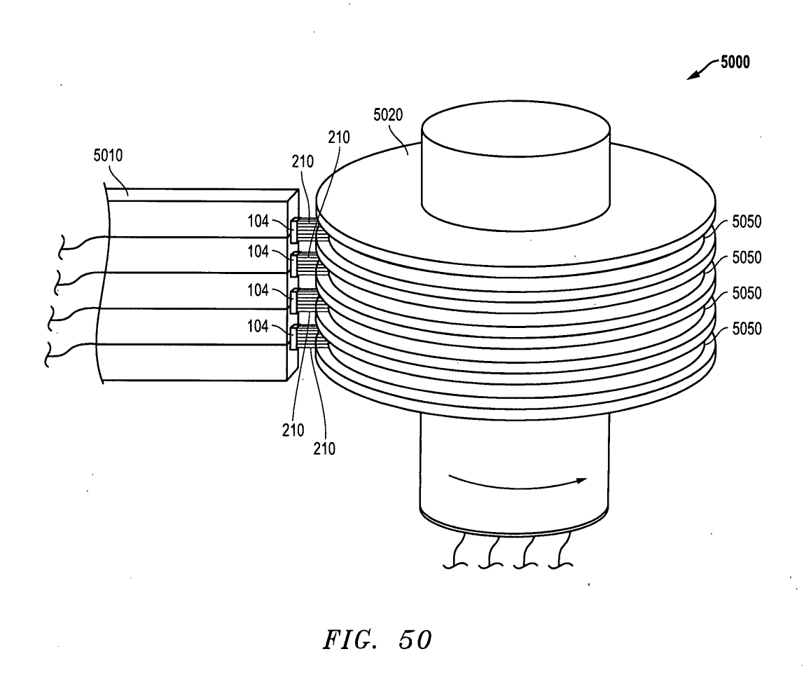

In yet other embodiments, electrical contacts may be provided using the methodology described herein for a wide variety of other connection applications, e.g., any connection application in which two or more electronic devices or any other type of assemblies having circuitry are to be electronically interconnected. Other examples of connection applications include those connection applications in which a first contact is moveable in relation to a second contact while the first and second contacts are in motion relative to each other. Examples of such contacts include, but are not limited to, contact brushes within electric motors, slip ring contacts, etc. In such applications, CNT (or nanowire) forests may be grown on one contact surface in order to make mechanical and electrical contact with another substantially planar (e.g., metal) contact surface. Advantages that may be realized in such an embodiment are corrosion resistance, durable wearing surfaces, and low friction between the moving parts. As an example, FIG. 50 illustrates an exemplary embodiment of a slip ring assembly 5000 having stationary stator component 5010 and rotatable rotor 5020 component. As shown, CNT (or nanowire) forests 210 are grown on contact pads 104 of stator 5010 and positioned in alignment with conductive contact grooves 5050 of rotor 5020 in order to make electrical contact therebetween while rotor component 5020 is moving relative to stator component 5010 as shown by the arrow. It will be understood that both components may be movable relative to each other in other embodiments.

While the invention may be adaptable to various modifications and alternative forms, specific embodiments have been shown by way of example and described herein. However, it should be understood that the invention is not intended to be limited to the particular forms disclosed. Rather, the invention is to cover all modifications, equivalents, and alternatives falling within the spirit and scope of the invention as defined by the appended claims. Moreover, the different aspects of the disclosed apparatus and methods may be utilized in various combinations and/or independently. Thus the invention is not limited to only those combinations shown herein, but rather may include other combinations.

What is claimed is:

1. An electrical interconnection system, comprising:
a first assembly having at least one conductive contact surface disposed thereon;
multiple carbon nanotube fibers or nanowires grown directly on the at least one contact surface of the first assembly, a first end of each of the multiple carbon nanotubes or nanowire fibers being permanently attached to the contact surface of the first assembly in a solderless manner; and
a second assembly positioned adjacent to the first assembly and having at least one conductive contact surface disposed thereon, the at least one contact surface of the second assembly being at least partially aligned with the at least one contact surface of the first assembly such that at least a portion of the individual carbon nanotube fibers or nanowires of the first assembly makes electrical and mechanical contact with the at least one conductive contact surface of the second assembly.

2. The system of claim 1, further comprising a third assembly having multiple conductive contact surfaces disposed thereon; and
wherein the first assembly comprises a captured contact array having opposing first and second sides, each of the first and second sides having multiple conductive contact surfaces disposed thereon, and having multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner;
wherein the first assembly is positioned between the second assembly and the third assembly, the second assembly having multiple conductive contact surfaces disposed thereon;
wherein each respective one of the multiple conductive contact surfaces of the second assembly is at least partially aligned with at least one corresponding contact surface of the first side of the first assembly such that at least a portion of the individual carbon nanotube fibers or nanowires of the corresponding conductive contact surface of the first side of the first assembly makes electrical and mechanical contact with the respective conductive contact surface of the second assembly; and
wherein each respective one of the multiple conductive contact surfaces of the third assembly is at least partially aligned with at least one corresponding contact surface of the second side of the first assembly such that at least a portion of the individual carbon nanotube fibers or nanowires of the corresponding conductive contact surface of the second side of the first assembly makes electrical and mechanical contact with the respective conductive contact surface of the third assembly.

3. The system of claim 1, wherein the second assembly comprises a ball grid array (BGA) device having multiple conductive contact surfaces disposed thereon in the form of solder balls; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the solder balls of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective solder ball of the second assembly.

4. The system of claim 1, wherein the second assembly comprises a land grid array (LGA) or leadless chip carrier (LCC) package device having multiple conductive contact surfaces disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the contact surfaces of the second assembly is at least partially aligned with at least, one corresponding contact surface of the first assembly such that at least a portion of the individual carbon nanotube fibers or nanowires of the corresponding conductive contact surface of the first assembly makes electrical and mechanical contact with the respective contact surface of the second assembly.

5. The system of claim 1, wherein the second assembly comprises a flip-chip device having multiple conductive solder bumps disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the solder bumps of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective solder bump of the second assembly.

6. The system of claim 1, wherein the second assembly comprises a bare die device having multiple conductive contact surfaces disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the contact surfaces of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective contact surface of the second assembly.

7. The system of claim 1, wherein the second assembly comprises an integrated circuit package device having multiple conductive contact surfaces in the form of conductive leads extending therefrom; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the conductive leads of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective conductive lead of the second assembly.

8. The system of claim 1, further comprising a third assembly having multiple conductive contact surfaces disposed thereon; and
wherein the first assembly comprises a bare die device having opposing first and second sides, each of the first and second sides having multiple conductive contact surfaces disposed thereon, and having multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner;
wherein the first assembly is positioned between the second assembly and the third assembly, the second assembly having multiple conductive contact surfaces disposed thereon;
wherein each respective one of the multiple conductive contact surfaces of the second assembly is at least partially aligned with at least one corresponding contact surface of the first side of the first assembly such that at least a portion of the individual carbon nanotube fibers or nanowires of the corresponding conductive contact surface of the first side of the first assembly makes electrical and mechanical contact with the respective conductive contact surface of the second assembly; and
wherein each respective one of the multiple conductive contact surfaces of the third assembly is at least partially aligned with at least one corresponding contact surface of the second side of the first assembly such that at least a portion of the individual carbon nanotube fibers or nanowires of the corresponding conductive contact surface of the second side of the first assembly makes electrical and mechanical contact with the respective conductive contact surface of the third assembly.

9. The system of claim 1, wherein the first assembly comprises a connector pin and the second assembly comprises a connector receptacle with the connector pin being received within the connector receptacle; or wherein the second assembly comprises a connector pin and the first assembly comprises a connector receptacle with the connector pin being received within the connector receptacle.

10. The system of claim 1, wherein the first assembly comprises a printed circuit board (PCB) card and the second assembly comprises a card edge connector with the PCB card being received within the card edge connector; or wherein the second assembly comprises a PCB card and the first assembly comprises a card edge connector with the PCB card being received within the card edge connector.

11. The system of claim 1, wherein the first assembly and second assembly are movable relative to each other while at the same time maintaining at least partial alignment and electrical and mechanical contact with each other.

12. A method of making electrical interconnections, comprising:
providing a first assembly having at least one conductive contact surface disposed thereon, wherein multiple carbon nanotube fibers or nanowires are grown directly on the at least one contact surface of the first assembly, a first end of each of the multiple carbon nanotubes or nanowire fibers being permanently attached to the contact surface of the first assembly in a solderless manner; and
providing a second assembly positioned adjacent to the first assembly and having at least one conductive contact surface disposed thereon, the at least one contact surface of the second assembly being at least partially aligned with the at least one contact surface of the first assembly such that at least a portion of the individual carbon nanotube fibers or nanowires of the first assembly makes electrical and mechanical contact with the at least one conductive contact surface of the second assembly.

13. The method of claim 12, wherein the first assembly comprises a captured contact array having opposing first and second sides, each of the first and second sides having multiple conductive contact surfaces disposed thereon, and having multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein the method further comprises:
providing a third assembly having multiple conductive contact surfaces disposed thereon such that the first assembly is positioned between the second assembly and the third assembly, the second assembly having multiple conductive contact surfaces disposed thereon;
wherein each respective one of the multiple conductive contact surfaces of the second assembly is at least partially aligned with at least one corresponding contact surface of the first side of the first assembly such that at least a portion of the individual carbon nanotube fibers or nanowires of the corresponding conductive contact surface of the first side of the first assembly makes electrical and mechanical contact with the respective conductive contact surface of the second assembly; and
wherein each respective one of the multiple conductive contact surfaces of the third assembly is at least partially aligned with at least one corresponding contact surface of the second side of the first assembly such that at least a portion of the individual carbon nanotube fibers or nanowires of the corresponding conductive contact surface of the second side of the first assembly makes electrical and mechanical contact with the respective conductive contact surface of the third assembly.

14. The method of claim 12, wherein the second assembly comprises a ball grid array (BGA) device having multiple conductive contact surfaces disposed thereon in the form of solder balls; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact, surface of the first assembly in a solderless manner; and, wherein each respective one of the solder balls of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective solder ball of the second assembly.

15. The method of claim 12, wherein the second assembly comprises a land grid array (LGA) or leadless chip carrier (LCC) package device having multiple conductive contact surfaces disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the contact surfaces of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective contact surface of the second assembly.

16. The method of claim 12, wherein the second assembly comprises a flip-chip device having multiple conductive solder bumps disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the solder bumps of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective solder bump of the second assembly.

17. The method of claim 12, wherein the second assembly comprises a bare die device having multiple conductive contact surfaces disposed thereon; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the contact surfaces of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective contact surface of the second assembly.

18. The method of claim 12, wherein the second assembly comprises an integrated circuit package device having multiple conductive contact surfaces in the form of conductive leads extending therefrom; wherein the first assembly comprises multiple conductive contact surfaces disposed thereon with multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein each respective one of the conductive leads of the second assembly is at least partially aligned with at least one corresponding contact surface of the first assembly such that at least a portion of the individual carbon nanotube fibers or nanowires of the corresponding conductive contact surface of the first assembly makes electrical and mechanical contact with the respective conductive lead of the second assembly.

19. The method of claim 12, wherein the second assembly has multiple conductive contact surfaces disposed thereon; wherein the first assembly comprises a bare die device having opposing first and second sides, each of the first and second sides having multiple conductive contact surfaces disposed thereon, and having multiple carbon nanotube fibers or nanowires grown directly on each of the multiple conductive contact surfaces with a first end of each of the multiple carbon nanotubes or nanowire fibers being permanently attached to a conductive contact surface of the first assembly in a solderless manner; and wherein the method further comprises:
providing a third assembly having multiple conductive contact surfaces disposed thereon such that the first assembly is positioned between the second assembly and the third assembly with each respective one of the multiple conductive contact surfaces of the second assembly being at least partially aligned with at least one corresponding contact surface of the first side of the first assembly such that at least a portion of the individual carbon nanotube fibers or nanowires of the corresponding conductive contact surface of the first side of the first assembly makes electrical and mechanical contact with the respective conductive contact surface of the second assembly; and such that each respective one of the multiple conductive contact surfaces of the third assembly is at least partially aligned with at least one corresponding contact surface of the second side of the first assembly such that at least a portion of the individual carbon nanotube fibers or nanowires of the corresponding conductive contact surface of the second side of the first assembly makes electrical and mechanical contact with the respective conductive contact surface of the third assembly.

20. The method of claim 12, wherein the first assembly comprises a connector pin and the second assembly comprises a connector receptacle with the connector pin being received within the connector receptacle; or wherein the second assembly comprises a connector pin and the first assembly comprises a connector receptacle with the connector pin being received within the connector receptacle.

21. The method of claim 12, wherein the first assembly comprises a printed circuit board (PCB) card and the second assembly comprises a card edge connector with the PCB card being received within the card edge connector; or wherein the second assembly comprises a PCB card and the first assembly comprises a card edge connector with the PCB card being received within the card edge connector.

22. The method of claim 12, wherein the first assembly and second assembly are movable relative to each other while at the same time maintaining at least partial alignment and electrical and mechanical contact with each other.

23. A device with an electrical interconnect, comprising:
a device substrate;
at least one external conductive contact surface disposed on an external surface of the device substrate; and
multiple carbon nanotube fibers or nanowires grown directly on the at least one external contact surface of the first assembly, a first end of each of the multiple carbon nanotubes or nanowire fibers being permanently attached to the contact surface of the first assembly in a solderless manner and a second end of each of the multiple carbon nanotubes or nanowire fibers freely extending outward for interconnection with another device.

24. The device of claim 23, wherein the device substrate comprises the substrate of a captured contact array having opposing external first and second sides, each of the first and second sides having multiple external conductive contact surfaces disposed thereon, and having multiple carbon nanotube fibers or nanowires grown directly on each of the multiple external conductive contact surfaces with a first end of each of the multiple carbon nanotubes or nanowire fibers being permanently attached to a conductive contact surface of the first assembly in a solderless manner and a second end of each of the multiple carbon nanotubes or nanowire fibers freely extending outward for interconnection with another device; and wherein the multiple external conductive contact surfaces of the captured contact array are positioned relative to each other such that each respective one of the multiple external conductive contact surfaces of the captured contact array partially aligns with at least one corresponding contact surface of another device having multiple contact surfaces such that at least a portion of the individual carbon nanotube fibers or nanowires of each respective external conductive contact surface of the captured contact array makes electrical and mechanical contact with the corresponding conductive contact surface of the other device when the captured contact array and other device are brought together in adjacent relationship.

25. The device of claim 23, wherein the device substrate comprises the substrate of a bare die device having opposing first and second sides, each of the first and second sides having multiple external conductive contact surfaces disposed thereon, and having multiple carbon nanotube fibers or nanowires grown directly on each of the multiple external conductive contact surfaces with a first end of each of the multiple carbon nanotubes or nanowire fibers being permanently attached to an external conductive contact surface of the bare die device in a solderless manner freely extending outward for interconnection with another device; and wherein the multiple external conductive contact surfaces of the bare die device are positioned relative to each other such that each respective one of the multiple external conductive contact surfaces of the bare die device partially aligns with at least one corresponding contact surface of another device having multiple contact surfaces such that at least a portion of the individual carbon nanotube fibers or nanowires of each respective external conductive contact surface of the bare die device makes electrical and mechanical contact with the corresponding conductive contact surface of the other device when the bare die device and other device are brought together in adjacent relationship.

26. The device of claim 23, wherein the device substrate comprises a connector pin substrate, and wherein the at least one external conductive contact surface of the connector pin is positioned to at least partially align and make electrical and mechanical contact with a conductive surface of a connector receptacle when the connector pin is received within the connector receptacle; or wherein the device substrate comprises a connector receptacle substrate, and wherein the at least one external conductive contact surface of the connector receptacle is positioned to at least partially align and make electrical and mechanical contact with a conductive surface of a connector pin when the connector pin is received within the connector receptacle.

27. The device of claim 23, wherein the device substrate comprises a printed circuit board (PCB) card substrate, and wherein the at least one external conductive contact surface of the PCB card is positioned to at least partially align and make electrical and mechanical contact with a conductive surface of a card edge connector when the PCB card is received within the card edge connector; or wherein the device substrate comprises a card edge connector substrate, and wherein the at least one external conductive contact surface of the card edge connector substrate is positioned to at least partially align and make electrical and mechanical contact with a conductive surface of a PCB card when the PCB card is received within the card edge connector.

28. The device of claim 23, wherein the device substrate comprises a first assembly substrate, and wherein the at least one external conductive contact surface of the first assembly is positioned to at least partially align and maintain electrical and mechanical contact with a conductive surface of a second assembly while the first and second assemblies are moving relative to each other.
